(19) United States
(12) Patent Application Publication
(10) Pub. No.: US 2025/0337677 A1
(43) Pub. Date: Oct. 30, 2025

(54) INFORMATION PROCESSING SYSTEM AND METHOD OF INFORMATION PROCESSING

(71) Applicant: FRONTEO, Inc., Tokyo (JP)

(72) Inventors: Toru HISAMITSU, Tokyo (JP); Yuichi KICHIKAWA, Tokyo (JP)

(21) Appl. No.: 19/022,715

(22) Filed: Jan. 15, 2025

(30) Foreign Application Priority Data
Apr. 25, 2024 (JP) 2024-071829

(51) Int. Cl. H04L 45/24; G06Q 10/0875

(52) U.S. Cl. CPC H04L 45/24; G06Q 10/0875

(57) ABSTRACT

An information processing system includes: a network obtaining unit configured to obtain an entity network in which a plurality of nodes corresponding one-to-one to a plurality of entities are connected together by edges each representing a trading relationship or a control relationship; and a path selecting unit configured to select a priority path of high priority from among a plurality of paths included in the entity network, wherein each of the plurality of nodes included in the entity network is provided with additional data representing a characteristic of the node, and the path selecting unit determines, for each of the plurality of paths, a feature amount based on the additional data, and selects the priority path based on the feature amount as determined.

### CROSS-REFERENCE TO RELATED APPLICATION

The present application claims priority from Japanese Application JP 2024-071829, filed Apr. 25, 2024, the content of which is hereby incorporated by reference into this application.

### BACKGROUND OF THE INVENTION

### 1. Field of the Invention

The present invention relates to, but not limited to, an information processing system and a method of information processing.

### 2. Description of the Related Art

Various conventional techniques are known for network analysis, such as supply chain analysis. A supply chain is a series of flow starting from the procurement of the raw materials and components of a product to the manufacture, inventory management, delivery, sale and consumption of the product.

For instance, Japanese Patent No. 7034447 discloses an information processing system that analyzes, in a supply chain, a subnetwork including at least one of upstream and downstream subnetworks of a company of interest, and that displays the analyzed result.

### SUMMARY OF THE INVENTION

A conventionally know method is analyzing a path, as in an example of determining a chokepoint based on a network structure (node-to-node connection relationship). However, such a conventional technique does not disclose a method for determining a high-priority path based on additional information given to a network's node.

Some aspects of the present disclosure can provide, but not limited to, an information processing system and a method of information processing that select a high-priority path in a target network.

One aspect of the present disclosure is directed to an information processing system including the following: a network obtaining unit configured to obtain an entity network in which a plurality of nodes corresponding one-to-one to a plurality of entities are connected together by edges each representing a trading relationship or a control relationship; and a path selecting unit configured to select a priority path of high priority from among a plurality of paths included in the entity network. Each of the plurality of nodes included in the entity network is provided with additional data representing a characteristic of the node. The path selecting unit determines, for each of the plurality of paths, a feature amount based on the additional data, and selects the priority path based on the feature amount as determined.

Another aspect of the present disclosure is directed to a method of information processing that is performed by an information processing system. The method includes obtaining an entity network in which a plurality of nodes corresponding one-to-one to a plurality of entities are connected together by edges each representing a trading relationship or a control relationship. Each of the plurality of nodes included in the entity network is provided with additional data representing a characteristic of the node. The method also includes the following: for each of a plurality of paths included in the entity network, determining a feature amount based on the additional data; and selecting, from among the plurality of paths, a priority path of high priority based on the feature amount as determined.

### BRIEF DESCRIPTION OF THE DRAWINGS

FIG. 1 illustrates an example of a system configuration including an information processing system according to an embodiment;

FIG. 2 is a functional block diagram illustrating an example of the detailed configuration of a server system;

FIG. 3 is a functional block diagram illustrating an example of the detailed configuration of a terminal device;

FIG. 4 is a flowchart schematically showing processing that is executed in the information processing system;

FIG. 5A is an example of the structure of data that is obtained in accordance with open information;

FIG. 5B illustrates an example of the structure of the data that is obtained in accordance with the open information;

FIG. 5C illustrates an example of part of a trading network that is obtained in accordance with the open information;

FIG. 6 is a schematic diagram illustrating the trading network;

FIG. 7 is a flowchart showing a process for determining a vectorial representation;

FIG. 8 is a flowchart showing a process for extracting an upstream trading subnetwork;

FIG. 9A illustrates an example of part of a trading subnetwork;

FIG. 9B illustrates an example of part of the trading subnetwork;

FIG. 10 illustrates an example of the trading subnetwork;

FIG. 11A is a flowchart showing processing to determine the vectorial representation of a node;

FIG. 11B is a flowchart showing processing to determine the vectorial representation of the node;

FIG. 12A illustrates an example of flow amounts in the trading subnetwork;

FIG. 12B illustrates an example of with-phase flow amounts in the trading subnetwork;

FIG. 13 illustrates an example of a complex vector corresponding to a given node;

FIG. 14 illustrates an example of with-phase flow amounts in the trading subnetwork;

FIG. 15 is a flowchart showing a process for extracting a supply chain network;

FIG. 16 is a flowchart showing a process for selecting a priority path;

FIG. 17 illustrates an example of a supply chain network;

FIG. 18 illustrates an example of the supply chain network with a loop removed therefrom;

FIG. 19 is a table showing examples of a path weight;

FIG. 20A is a table showing examples of a tag-transition-pattern weight;

FIG. 20B is a table showing examples of the tag-transition-pattern weight;

FIG. 21 is a table showing examples of the tag-transition-pattern weight after update;

FIG. 22 is a table showing exemplary sort results based on the tag-transition-pattern weights;

FIG. 23A is a table showing exemplary candidates for a priority path;

FIG. 23B illustrates processing to select a priority path;

FIG. 24 illustrates examples of a priority path in a supply chain network;

FIG. 25 illustrates another example of the supply chain network;

FIG. 26A is a table showing examples of a tag-transition-pattern weight after update;

FIG. 26B is a table showing examples of a candidate path that is a candidate for a priority path;

FIG. 26C illustrates processing to select a priority path;

FIG. 27 illustrates an example of a subnetwork;

FIG. 28A is a table showing examples of a tag-transition-pattern weight after update;

FIG. 28B is a table showing examples of a candidate path that is a candidate for a priority path;

FIG. 28C illustrates processing to select a priority path;

FIG. 29 is another flowchart showing processing to select the priority path;

FIG. 30 illustrates another example of the supply chain network;

FIG. 31 illustrates examples of a text associated with each node (company);

FIG. 32 is a table showing difference vectors;

FIG. 33 is a table showing examples of the inner product of first and second difference vectors;

FIG. 34 illustrates an example of the feature amount (inner product) of each edge of the supply chain network; and

FIG. 35 is a table showing examples of the feature amount of a path.

### DETAILED DESCRIPTION OF THE INVENTION

An embodiment will be described with reference to the drawings. Throughout the drawings, identical or equivalent constituents will be denoted by the same signs, and the description of redundancies about such constituents will be omitted. Note that this embodiment described below will not unduly limit the contents recited in the claims. Furthermore, not all of the configurations described in this embodiment are necessarily essential constituent features of the present disclosure.

### 1. Example of System Configuration

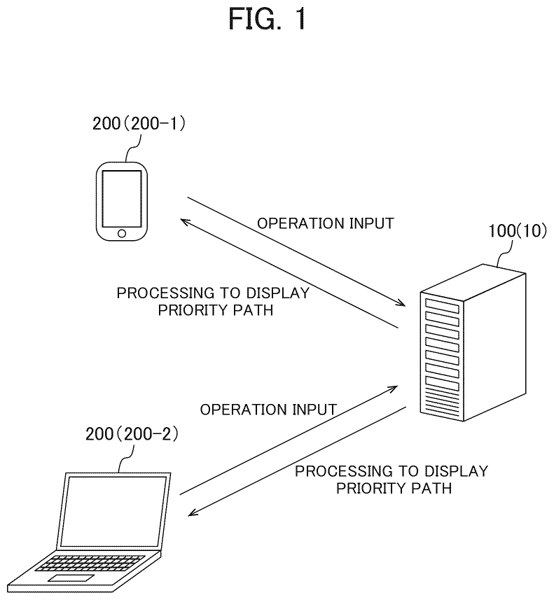

FIG. 1 illustrates an example of a system configuration including an information processing system 10 according to an embodiment. The system according to this embodiment includes a server system 100 and a terminal device 200. It is noted that the system configuration including the information processing system 10 is not limited to that in FIG. 1; the system can be modified in various manners such that, for instance, the configuration may be omitted partly, or another configuration may be added. Although FIG. 1 illustrates, by way of example, the terminal device 200 includes two terminal devices, which are a terminal device 200-1 and a terminal device 200-2, the terminal device 200 may include any number of terminal devices.

The information processing system 10 according to this embodiment corresponds to the server system 100 for instance. It is noted that the technique in this embodiment is not limited to the foregoing; the information processing system 10 may execute a process, which will be described in the Specification, through distributed processing by the use of the server system 100 and another device. For instance, the information processing system 10 according to this embodiment may be implemented through distributed processing by the use of the server system 100 and terminal device 200. The Specification will describe an instance where the information processing system 10 is a server system 100.

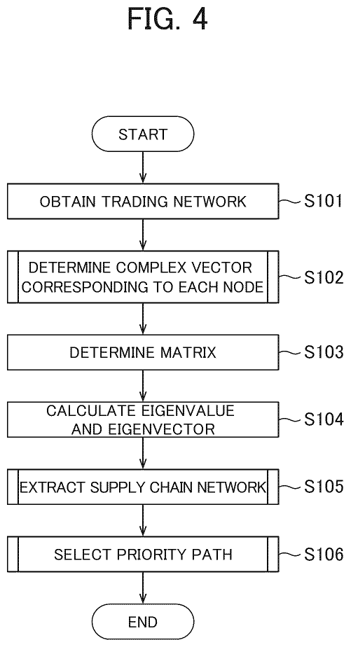

The server system 100 may be a single server or include a plurality of servers. For instance, the server system 100 may include a database server and an application server. The database server stores various kinds of data, including a first network 121 and a complex vector, both of which will be described later on. The application server executes processing that will be described later on with reference to, but not limited to, FIGS. 4, 7, 8, 11A, 11B, 15, 16, and 29. It is noted that the plurality of servers herein may be physical servers or virtual servers. It is also noted that when virtual servers are used, they may be provided in a single physical server or distributed to a plurality of physical servers. As described above, the specific configuration of the server system 100 according to this embodiment can be modified in various manners.

The server system 100 communicates with the terminal device 200-1 and terminal device 200-2 over, for instance, a network. Hereinafter, a plurality of terminal devices will be simply referred to as a terminal device 200 unless these terminal devices have to be distinguished from each other. The network, although being herein a public communication network, such as the Internet, may be a local area network (LAN) or other things.

The terminal device 200 is a device that is used by a user of the information processing system 10. The terminal device 200 may be a personal computer (PC), a mobile terminal device, such as a smartphone, or any other like device having a function that will be described in the Specification.

The information processing system 10 according to this embodiment is an open-source intelligence (OSINT) system for, but not limited to, collecting and analyzing data relating to a target by the use of, for instance, open information. The open information herein includes various kinds of information widely accessible and legally available. For instance, the open information may include securities reports, inter-industry relations tables, official announcements of a government, news reports on countries and companies, and supply chain databases. Further, the open information may include various kinds of information that are transmitted and received via a social networking service (SNS). For instance, the SNS may include services that allow texts, images or other things to be posted, and the open information in this embodiment may include these texts or images, or include their results obtained through natural language processing, image processing or other processing.

The server system 100 generates nodes including various attributes on the basis of the open information. A single node represents a given entity. Although the entity herein is a company for instance, the entity may include another organization, such as a public agency, or include an individual. Attributes provided to a node are various kinds of information, such as the entity's name, nationality, business field, industrial classification, trading partners, and trading goods, that are determined based on the open information. For example, a node is provided with a tag as metadata. This tag includes the attribute values of the foregoing various attributes. When a node representing an entity is a company, the node is provided with attributes related to this company. It is noted that the attributes herein may include, but not limited to, sales, the number of employees, shareholders and their capital contribution ratios, and board members. In this embodiment, at least an industrial classification among these attributes may be provided to a node. The industrial classification is the kind of an industry classified by a characteristic of the industry. Industrial classification codes, for instance, may be used as an industrial classification. The industrial classification codes are information with a code, such as “01”, assigned to individual industries classified into several fields. The industrial classification codes, although being the North American Industry Classification System (NAICS) for instance, may be another classification code, such as the International Standard Industrial Classification or the Japan Standard Industrial Classification.

When there is a relationship between a given node and another node, the given node and other node are connected together by an edge having a direction. For instance, let a given company provide (sell) a trading product of some kind to another company. In this case, a node corresponding to the other company, and a node corresponding to the given company are connected together by an edge provided with an attribute representing the product's buy-sell relationship (distribution relationship). The edge herein is an edge having a direction from an influencing entity to an influenced entity, that is, for instance, from a seller to a buyer of a product of some kind. That is, the edge represents a trading relationship in which a supply source company of a product is associated with a supply destination company of the product. In addition, the attribute provided to the edge is not limited to the product; various kinds of information, including, a start company, an end company, and a product as well as its price and the quantity (number) of trading products, can be included. It is noted that such information about the product is not an essential attribute that is to be provided to the edge, and can be thus omitted. It is also noted that the same holds true for the other information pieces, such as a start company; these information pieces may be provided to the edge as attributes or omitted.

The server system 100 in the technique according to this embodiment obtains an entity network (first network), which is a network in which a plurality of nodes representing a plurality of entities are connected together by a plurality of edges each representing a trading relationship or a control relationship. Since the edges have directions, the entity network is a directed graph. The server system 100 performs processing to conduct an analysis based on the entity network, and present the analyzed result. For instance, the terminal device 200 is a device that is used by a user who uses a service provided by the OSINT system. For instance, the user uses the terminal device 200 to send a request to the server system 100, which is the information processing system 10, to conduct an analysis of some kind. The server system 100 conducts an analysis based on the entity network and transmits the analyzed result to the terminal device 200.

When the entity network is a network representing a company-to-company trading relationship, there are two kinds of paths in the entity network: (A) a chain (upstream) of trading of various items such as components and materials actually pertaining to a product of a company and/or a chain (downstream) of trading of the company's product; and (B) a chain in which multiple trading matters not directly pertaining to the company are linked by chance. As such, this embodiment will describe an entity network representing a trading relationship obtained based on open information as a trading network, and a part of the entity network pertaining to substantial trading on a given company as a supply chain network. That is, a trading network is a network including both (A) and (B) above, and a supply chain network related to a given company is a network presumably including (A) without (B). The server system 100 may perform processing to extract the supply chain network from the trading network.

However, networks that undergo processing in this embodiment are not limited to a trading network and a supply chain network. For instance, the entity network may be a network representing an entity-to-entity control relationship. To be more specific, the entity network may be a shareholding network representing a company-to-company stock-based control relationship.

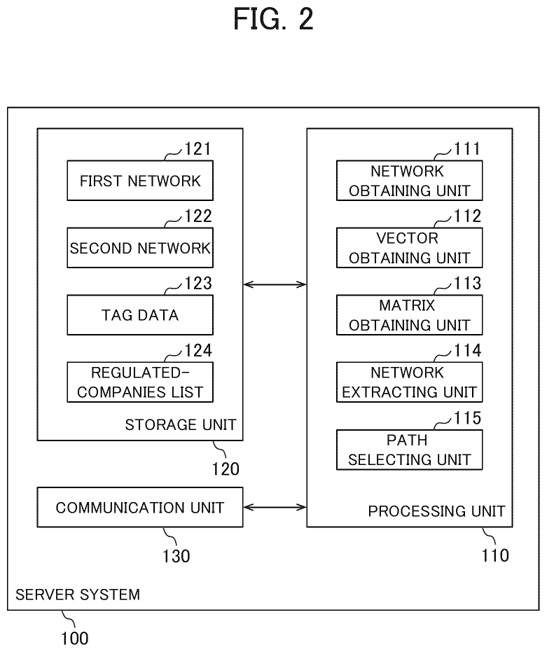

FIG. 2 is a functional block diagram illustrating an example of the detailed configuration of the server system 100. The server system 100 includes, as illustrated in FIG. 2 for instance, a processing unit 110, a storage unit 120, and a communication unit 130. It is noted that the configuration of the server system 100 is not limited to the example in FIG. 2; the configuration can be subjected to various modifications, such as omitting part of the configuration, or adding another configuration.

The processing unit 110 in this embodiment is formed from hardware below. The hardware can include at least one of a digital-signal processing circuit and an analog-signal processing circuit. For instance, the hardware can be formed from one or more circuit devices mounted on a circuit board, or one or more circuit elements mounted on the same. Examples of one or more circuit devices include an integrated circuit (IC) and a field-programmable gate array (FPGA). Examples of one or more circuit elements include resistors and capacitors.

Further, the processing unit 110 may be implemented in the form of a processor below. The server system 100 according to this embodiment includes a memory that stores information, and a processor that operates on the basis of the information stored in the memory. Examples of the information include a program and various kinds of data. The program may include a program to cause the server system 100 to execute processing that will be described in the Specification. The processor includes hardware. The processor can be various kinds of processors, including a central processing unit (CPU), a graphics processing unit (GPU), and a digital signal processor (DSP). The memory may be a semiconductor memory, such as a static random access memory (SRAM), a dynamic random access memory (DRAM), or a flash memory; alternatively, the memory may be a resistor; alternatively, the memory may be a magnetic storage device, such as a hard disk drive (HDD); alternatively, the memory may be an optical storage device, such as an optical disc device. For instance, the memory stores a computer-readable instruction, which is executed by the processor to thus implement the function of the processing unit 110 as a process. The instruction herein may be a set of instructions constituting the program, or an instruction for instructing a hardware circuit of the processor to operate.

The processing unit 110 includes, for instance, a network obtaining unit 111, a vector obtaining unit 112, a matrix obtaining unit 113, a network extracting unit 114, and a path selecting unit 115. It is noted that the processing unit 110 does not need to include all the constituents illustrated in FIG. 2. For example, the processing unit 110 may obtain a shareholding network as the entity network. In this case, the vector obtaining unit 112, matrix obtaining unit 113, and network extracting unit 114, and other units, which are all constituents pertaining to extracting a second network 122 (in a narrow sense, a supply chain network), may be omitted.

The network obtaining unit 111 obtains the first network 121 in which a plurality of nodes corresponding one-to-one to a plurality of entities are connected together by edges each representing a trading relationship or a control relationship. For instance, the network obtaining unit 111 may generate an entity network on the basis of open information and define the entity network as the first network 121. The open information includes trading relationship information in which a supply source company of a product is associated with a supply destination company of the product, or control relationship information indicating, but not limited to, a shareholding ratio. The network obtaining unit 111 stores the generated first network 121 in the storage unit 120. It is noted that the first network 121 may be generated in a system that is different from the information processing system 10 according to this embodiment. The network obtaining unit 111 in this case may perform processing to obtain a generated result from this different system.

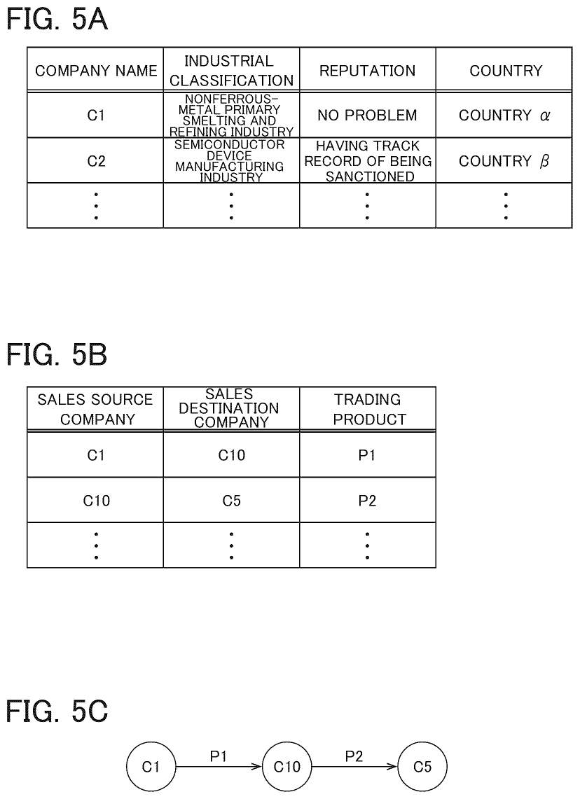

As will be described later on with reference to FIGS. 5A to 5C for instance, the network obtaining unit 111 may obtain, as the first network 121, a network in which a plurality of nodes corresponding to a plurality of companies are connected together, in accordance with a company-to-company trading relationship.

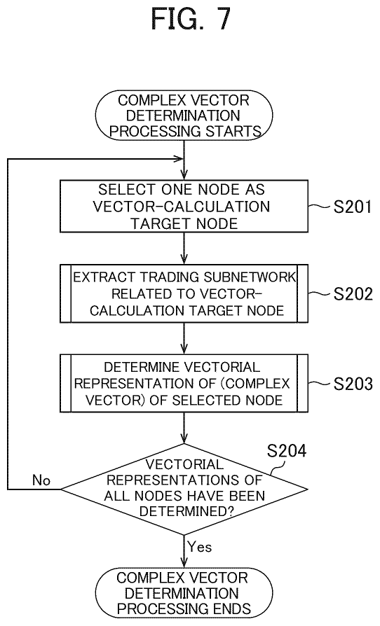

The vector obtaining unit 112 obtains the vectorial representation (complex vector) of each node included in the first network 121. To be specific, the vector obtaining unit 112 selects any one of a plurality of nodes as a vector-calculation target node and determines, for each of the plurality of nodes, a complex vector representing the relationship of this vector-calculation target node with another one of the plurality of nodes by assigning a complex number having a phase corresponding to the distance to the vector-calculation target node, and having an absolute value corresponding to the amount of flow going to or coming from the vector-calculation target node. How to determine the vector representation will be described later on with reference to FIGS. 7 to 14 and others. The vector obtaining unit 112 stores the obtained complex vector of each node in the storage unit 120.

The matrix obtaining unit 113 determines a complex correlation matrix C in accordance with the complex vector of each node obtained by the vector obtaining unit 112. The matrix obtaining unit 113 also determines an eigenvalue and an eigenvector by subjecting the complex correlation matrix C to eigenvalue decomposition.

The network extracting unit 114 extracts the second network 122, which is a part of the first network 121, on the basis of the complex vector representing each of the plurality of nodes. To be specific, the network extracting unit 114 may extract a supply chain network representing a substantial trading relationship of a given company as the second network 122 from a trading network (first network 121) on the basis of the eigenvector.

The path selecting unit 115 selects a high-priority path from among a plurality of paths included in an entity network. The entity network herein is, for instance, the second network 122, which is a supply chain network. It is noted that an entity network to undergo such priority path selection may be the second network 122 other than a supply chain network, or the first network 121.

The storage unit 120 is a working region for the processing unit 110 and stores various kinds of information. The storage unit 120 can be implemented in the form of various kinds of memory; the memory may be a semiconductor memory, such as an SRAM, a DRAM, a ROM, and a flash memory; alternatively, the memory may be a resistor; alternatively, the memory may be a magnetic storage device, such as a hard disk drive; alternatively, the memory may be an optical storage device, such as an optical disc drive.

The storage unit 120 stores the first network 121 obtained by the network obtaining unit 111 for instance. The storage unit 120 also stores the second network 122 extracted by the network extracting unit 114. Further, the storage unit 120 may store open information, such as securities reports and inter-industry relations tables, as information indicating a trading relationship or a control relationship. For instance, the storage unit 120 stores, but not limited to, tag data 123 and a regulated-companies list 124. The tag data 123 is tag-related information and is, for instance, a set of attribute values (candidate tag values) in a given attribute. The tag data 123 may be an industrial classification code for instance. It is noted that a tag may include various kinds of information, such as a country, a company ID, the category of an entity, and that tag data may include information about these tags. The regulated-companies list 124 is information for specifying a company having a problem in view of, for example, ESG. Other than the foregoing, the storage unit 120 can store various kinds of information related to the processing that is executed in this embodiment.

The communication unit 130 is an interface for communication over a network and includes, for instance, an antenna, a radio frequency (RF) circuit, and a baseband circuit. The communication unit 130 may operate under the control of the processing unit 110 or include a communication controlling processor that is different from the processing unit 110. The communication unit 130 is an interface for performing communication in accordance with, for instance, the transmission control protocol/Internet protocol (TCP/IP). It is noted that the specific communication scheme can be modified in various manners.

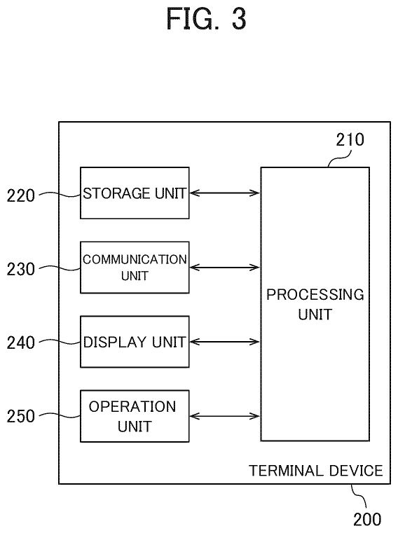

FIG. 3 is a block diagram illustrating an example of the detailed configuration of the terminal device 200. The terminal device 200 includes a processing unit 210, a storage unit 220, a communication unit 230, a display unit 240, and an operation unit 250.

The processing unit 210 is formed from hardware including at least one of a digital-signal processing circuit and an analog-signal processing circuit. Further, the processing unit 210 may be implemented in the form of a processor. The processor can be various processors, such as a CPU, a GPU, and a DSP. The processor executes an instruction stored in the memory of the terminal device 200, so that the function of the processing unit 210 is implemented in the form of a process.

The storage unit 220 is a working region of the processing unit 210 and is implemented in the form of various memories, such as an SRAM, a DRAM, and a ROM.

The communication unit 230 is an interface for communication over a network and includes, for instance, an antenna, an RF circuit, and a baseband circuit. The communication unit 230 communicates with the server system 100 over, for instance, a network.

The display unit 240 is an interface that displays various kinds of information. The display unit 240 may be a liquid crystal display, an organic EL display, or a display that operates under any other scheme. The operation unit 250 is an interface that receives an input operated by the user. The operation unit 250 may be, but not limited to, buttons provided in the terminal device 200. Further, the display unit 240 and operation unit 250 may be combined together to constitute a touch panel.

As described above, the information processing system 10 according to this embodiment includes the network obtaining unit 111 and the path selecting unit 115. Each of a plurality of nodes included in an entity network is provided with additional data representing the characteristic of the node. The path selecting unit 115 may determine a feature amount for each of a plurality of paths on the basis of the additional data and select a priority path based on the feature amount as determined. Doing so can appropriately select a high-priority path on the network on the basis of the additional data provided to the nodes. For instance, a highly important path (highly important trading flow) can be selected in a supply chain between two companies when the entity network is a supply chain network. The information processing system 10 controls the display unit 240 of the terminal device 200 to display, for instance, the selected priority path.

Here, the additional data provided to the nodes may be a tag representing an industrial classification, a country, or other things. When the additional data is a tag, the feature amount is the weight of each path on the network (path weight) and the weight of a tag transition pattern (tag-transition-pattern weight) representing how the tag transitions along a plurality of nodes included in the path.

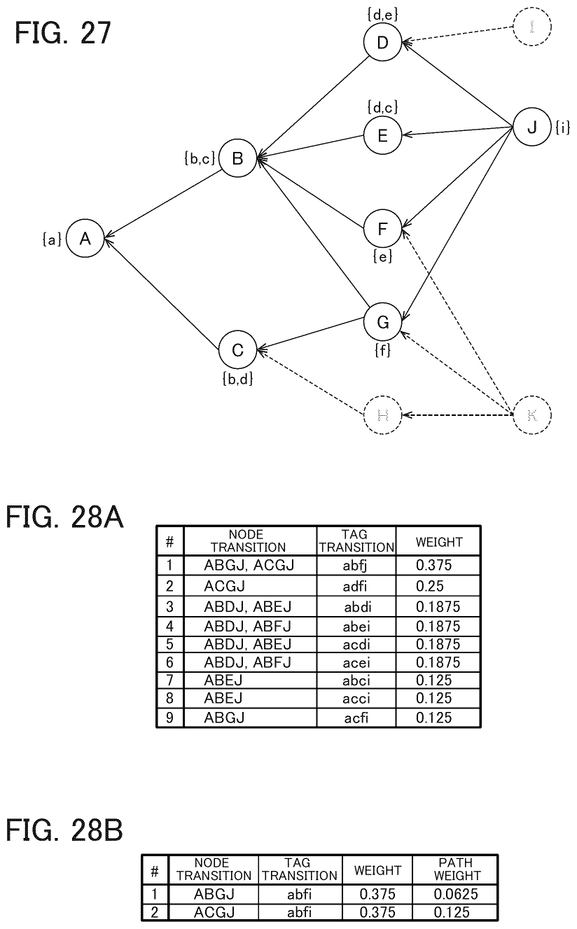

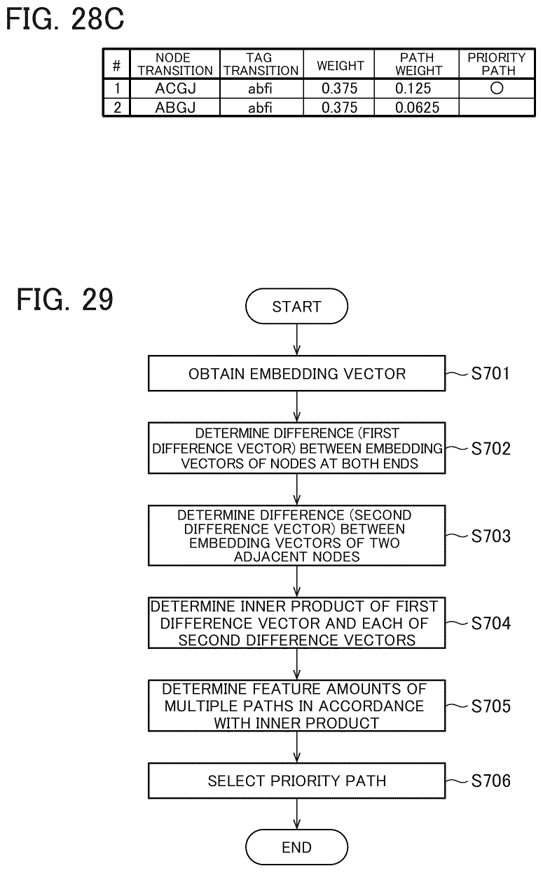

As will be described later on with reference to FIGS. 19, 21 and others, the path weight and the tag-transition-pattern weight can be determined through easy operations, and even if the the network enlarges in scale, there is a low probability that the amount of calculation increases excessively. Thus, the technique according to this embodiment can determine a priority path between two nodes in a target network in a wide range (in a narrow sense, the entire) of the network. In this embodiment, once the path weight and the tag-transition-pattern weight are calculated, the feature amount of each path can be easily recalculated when a subnetwork is a target. For example, the technique in this embodiment enables high-speed reselection of a priority path even when the two nodes at the path's endpoints are switched. Processing targeted at a subnetwork will be described with reference to FIGS. 27 to 28C.

Furthermore, in the technique in this embodiment, since the tag-transition-pattern weight is determined once the path weight is calculated, the priority path can be determined. Thus, a processing target network in the technique according to this embodiment is not limited to a trading network and a supply chain network; it can be broadened to various networks in which the path weight (weight at the end node on the path) can be calculated.

Alternatively, the additional data provided to the nodes may be a vector (embedding vector) determined from a text representing a node characteristic, as will be described later on. When the additional data is an embedding vector, the feature amount is determined from the inner product of a first difference vector, which is a difference in embedding vector between two nodes constituting endpoints, and a second difference vector, which is a difference in embedding vector between two adjacent nodes. A detailed example will be described with reference to FIGS. 29 to 35.

As described above, the entity network may be obtained in this embodiment on the basis of the open information. At this time, an attribute type provided in accordance with a node may vary, and only one of an industrial classification code and a text representing a characteristic may be obtained. Accordingly, a priority path in a network can be determined appropriately in accordance with an obtained attribute by implementing both, as described above, a process based on a tag transition pattern corresponding to an industry classification, and a process based on an embedding vector determined from a text, and by using these processes in a mutually complementary manner.

Further, the processing that is performed by the information processing system 10 according to this embodiment may be, in part or in whole, implemented in the form of a program. The processing that is performed by the information processing system 10 is, in a narrow sense, processing that is performed by the processing unit 110 of the server system 100, but may include processing that is performed by the processing unit 210 of the terminal device 200.

The program according to this embodiment can be stored in a non-transitory information storing medium (information storing device), an example of which is a computer-readable medium. The information storing medium can be implemented in the form of, but not limited to, an optical disk, a memory card, an HDD, or a semiconductor memory. The semiconductor memory is a ROM for instance. The processing unit 110 and others perform various kinds of processing in this embodiment based on a program stored in the information storing medium. That is, the information storing medium stores a program for causing a computer to function as the processing unit 110 and others. The computer is a device provided with an input device, a processing unit, a storage unit, and an output unit. To be specific, the program according to this embodiment is a program for causing the computer to execute individual process steps that will be described later on with reference to FIG. 4 and other drawings.

The technique in this embodiment is also applicable to a method of information processing including process steps described below. The method of information processing includes the following steps that are performed by an information processing device: obtaining an entity network in which a plurality of nodes corresponding one-to-one to a plurality of entities are connected together by edges each representing a trading relationship or a control relationship; determining a feature amount for each of a plurality of paths included in the entity network in accordance with additional data; and selecting a priority path of high priority from among the plurality of paths in accordance with the feature amount as determined. As earlier described, the additional data is data indicating a node characteristic provided to each of the plurality of nodes included in the entity network.

### 2. Details of Processing

The processing in this embodiment will be detailed. The following describes an instance where the first network 121 is a trading network in which a plurality of nodes corresponding one-to-one to a plurality of companies are connected together by edges each representing a trading relationship, and where the second network 122 is a supply chain network representing a supply chain of a company of interest. Doing so enables a high-priority path to be determined in the supply chain network of the company of interest. It is noted that the entity network according to this embodiment is not limited to a supply chain network. It is also noted that extracting the second network 122 is not essential, and that the first network 121 may be used as a network that undergoes priority-path selection.

### 2.1 Overall Flow

FIG. 4 is a flowchart schematically illustrating processing that is executed in the information processing system 10 according to this embodiment.

In Step S101, the network obtaining unit 111 firstly obtains a trading network, which is the first network 121. The network obtaining unit 111 stores the trading network in the storage unit 120.

In Step S102, the vector obtaining unit 112 determines a vectorial representation for each of a plurality of nodes included in the trading network. The vector obtaining unit 112 stores the determined vectorial representation in the storage unit 120. The vectorial representation herein is a vector representing a network structure denoting how each node is connected to other nodes, and is a vector different from an embedding vector (which will be described later on with reference to FIGS. 29 to 35), which is exemplary additional data.

In Step S103, the matrix obtaining unit 113 determines a complex correlation matrix C in accordance with the vectorial representation. In Step S104, the matrix obtaining unit 113 subjects the complex correlation matrix C to eigenvalue decomposition to determine an eigenvalue and an eigenvector. The matrix obtaining unit 113 stores at least the eigenvector in the storage unit 120.

In Step S105, the network extracting unit 114 extracts a supply chain network, which is the second network 122, from the trading network in accordance with the eigenvector. For instance, the network extracting unit 114 may extract the supply chain network of a company that is an entity of interest.

In Step S106, the path selecting unit 115 selects a priority path from among a plurality of paths included the supply chain network extracted in Step S105.

The following details processing in each step.

### 2.2 Obtainment of Trading Network

Processing to obtain a trading network, which corresponds to Step S101 in FIG. 4, will be described. The network obtaining unit 111 may generate the trading network on the basis of open information. The open information includes information, such as securities reports and press releases.

The network obtaining unit 111 specifies, for each of many companies, various kinds of information, such as the name, nationality, business field, business partners and trading goods of the company. The network obtaining unit 111 may also specify, but not limited to, the number of employees, shareholders as well as their capital contribution ratio, and board members of each company on the basis of the open information.

The network obtaining unit 111 may also obtain reputation information indicating a reputation of each company on the basis of the open information. For instance, the reputation information is information indicating, but not limited to, whether a target company has a problem or a history of being sanctioned in view of environment, social, and governance (ESG). For instance, the reputation information may be information indicating, but not limited to, that a target company is a company violated export regulations, a company handling conflict minerals, a company involved in slave labor, or a company involved in illegal logging. Further, the open information may be a document issued by, for instance, a government institute, and the reputation information may be information indicating whether a target company is subjected to restriction on trading with a predetermined country or others. Further, as earlier described, the open information may include information about an SNS; the reputation information herein may be information determined based on an SNS. For instance, the network obtaining unit 111 may obtain the reputation information in accordance with SNS information sent from the official account of a company or others. Further, the SNS information that is used in the technique in this embodiment shall not be limited to information sent from an official account. For instance, when a predetermined number or more of users have sent out the name of a given company along with a word, such as “conflict minerals”, “slave labor”, or “illegal logging” on an SNS, the given company may be associated with negative reputation information.

FIGS. 5A and 5B illustrate examples of a data structure that is obtained based on open information. As illustrated in FIG. 5A, the network obtaining unit 111 obtains information in which each company included in the open information is associated with a company name, an industrial classification, a reputation, and a nationality.

The company name is, for instance, text data indicating the name of a target company. The industrial classification is information indicating the business field of the target company. The reputation is, as described above, information indicating whether the target company has a problem in view of ESG. The nationality is information indicating a country to which the target company belongs.

It is noted that although the industrial classification is shown in the form of texts in FIG. 5A, the information indicating the industrial classification may be denoted by an industrial classification code. For the Japan Standard Industrial Classification for instance, a code “231” is assigned to the primary smelting and refining of non-ferrous metals, and a code “2813” is assigned to the semiconductor devices. It is noted that the industrial classification may be another classification, such as NAICS, as earlier described. For convenience in description, the industrial classification will be hereinafter a text indicating a classification name. It is noted that the classification name in the following processing can be substituted for an industrial classification code. Further, the storage unit 120 may contain the tag data 123, as illustrated in FIG. 2, which is information in which, for instance, a classification name and a classification code in NAICS are associated with each other. The processing unit 110 may execute conversion processing between the classification name and classification code on the basis of the tag data 123.

Further, as illustrated in FIG. 5B, the network obtaining unit 111 obtains information indicating company-to-company trading on the basis of the open information. For instance, such trading relationship information included in the open information is the information illustrated in FIG. 5B, or information capable of specifying the information illustrated in FIG. 5B. The information indicating the company-to-company trading is information in which, for instance, information for identifying a sales source company, information for identifying a sales destination company, and information for identifying a product to be traded are associated with one another.

Based on these information items, the network obtaining unit 111 generates a trading network in the form of a directed graph in which companies are represented by nodes, and in which their trading relationships are represented by edges.

FIG. 5C illustrates part of a trading network generated based on the trading relationship shown in FIG. 5B. FIG. 5B shows a relationship in which a company C1 sells a product P1 to a company C10. The network obtaining unit 111 in this case provides an edge directed from C1 to C10, between a node representing the company C1 and a node representing the company C10. As illustrated in FIG. 5A, the node representing the company C1 is associated with the company name “C1”, and further with information on items, such as an industrial classification, a reputation, and a nationality. The same applies to the node representing the company C10. Further, the edge directed from C1 to C10 is associated with P1, which denotes a traded product. It is noted that the network obtaining unit 111 may obtain information, such as a trading volume and a trading price, on the basis of the open information, and that these information items may be associated with an edge.

FIG. 5B also shows a relationship in which the company C10 sells a product P2 to a company C5. The network obtaining unit 111 in this case provides an edge directed from C10 to C5, between the node representing the company C10 and a node representing the company C5. Each of the nodes is associated with the information illustrated in FIG. 5A, and each of the edges is associated with information on a traded product and other things.

It is noted that as earlier described, a provider (seller) of a product of some sort is referred to as “upstream” in a trading network, which is a directed graph, and a receiver (buyer) of the product of some sort is referred to as “downstream” in the same. It is noted that the same definition of upstream and downstream is also applied to a supply chain network, which will be described later on.

A trading network herein is, in a narrow sense, a network including nodes corresponding to all companies included in open information that is to be processed. Thus, the trading network may be a network including so many nodes, and the number of nodes may be approximately several thousand or more. It is noted that the configuration of the trading network may be modified in various manners; an example is deleting some of the companies included in the open information.

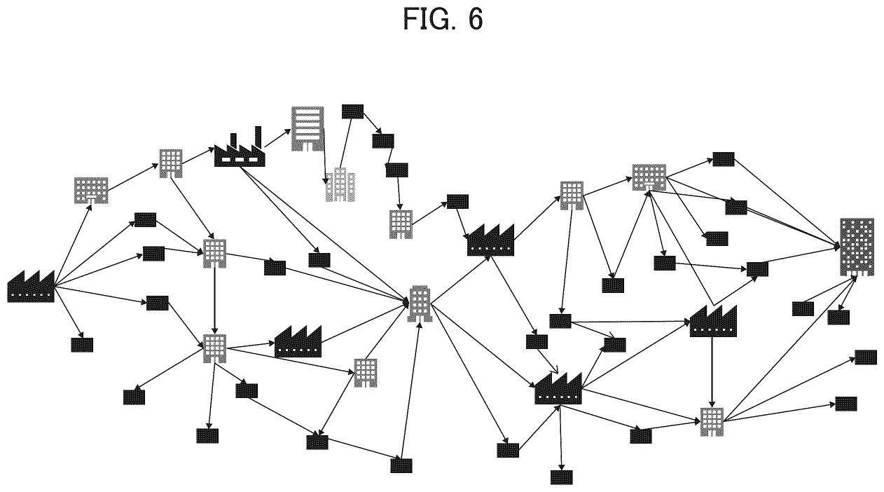

FIG. 6 is a schematic diagram illustrating a trading network. As illustrated in FIG. 6, the trading network is a directed graph in which a plurality of nodes are connected together by edges representing trading relationships. It is noted that for easy illustration, the nodes in FIG. 6 are depicted in different shapes, depending on whether the nodes represent manufacturing plants, distribution hubs, or other things. As earlier described, the obtained information includes, but not limited to, the names and industrial classifications of companies corresponding to the respective nodes; hence, the display mode of the trading network can be changed depending on, for instance, the industrial classifications. It is noted that the technique in this embodiment does not necessarily require such node shape control.

It is noted that FIGS. 5A and 5B illustrate examples of a data structure related to a trading network; a specific data structure shall not be limited to these examples. For instance, although FIGS. 5A and 5B illustrate an instance where table data, such as a relational database, is used, data having another structure may be used. Further, even in the use of table data, the number of tables shall not be limited to two; the tables may be managed in the form of either one combined table, or three or more divided tables. Furthermore, some of the items illustrated in FIGS. 5A and 5B may be omitted, or another item may be added. For instance, the network obtaining unit 111 may obtain information indicating company names, industrial classification codes, and buy-sell directions and may omit other information.

### 2.3 Calculation of Vectorial Representation

### 2.3.1 Extraction of Trading Network Related to Vector-Calculation Target Node

FIG. 7 is a flowchart showing a process for determining a complex vector, which corresponds to in Step S102 in FIG. 4. Upon the start of this process, the vector obtaining unit 112 firstly selects one of a plurality of nodes included in the trading network as a vector-calculation target node.

In Step S202, the vector obtaining unit 112 extracts a trading subnetwork related to the vector-calculation target node. The trading subnetwork is a network included in the trading network and including the vector-calculation target node.

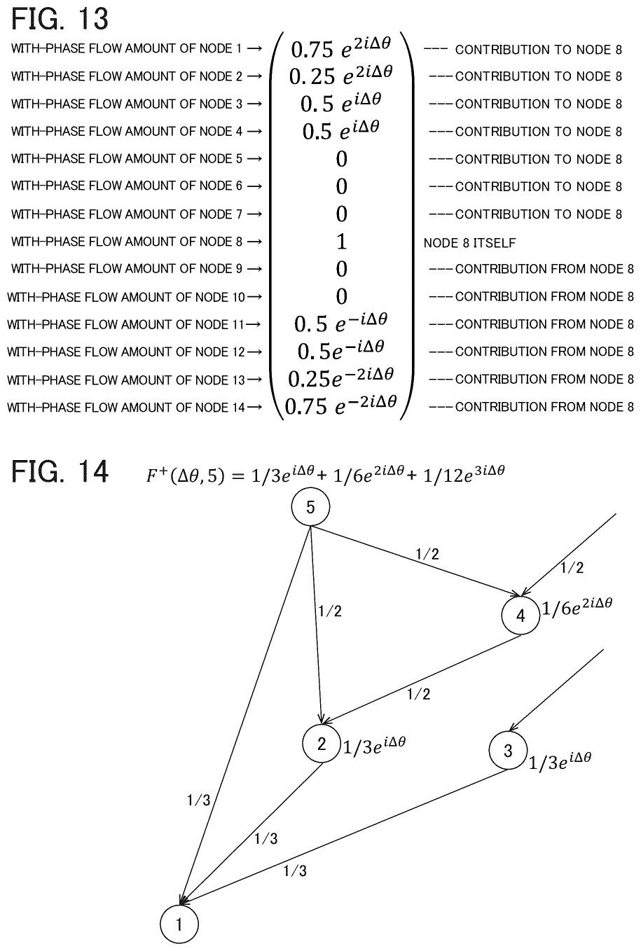

In Step S203, the vector obtaining unit 112 determines the vectorial representation of the vector-calculation target node in accordance with the trading subnetwork extracted in Step S202. The vector herein is, as will be described later on with reference to FIG. 13, a complex vector including elements each of which is a complex number having a size and a phase.

In Step S204, the vector obtaining unit 112 determines whether the vectorial representations of all the nodes included in the trading network have been determined. If there is a node whose vectorial representation has not yet been calculated (if NO in Step S204), the process goes back to Step S201 and continues. For instance, the vector obtaining unit 112 selects a node whose complex vector has not yet been calculated as a vector-calculation target node and determines the vectorial representation of this vector-calculation target node.

If the vectorial representations of all the nodes have been calculated (if YES in Step S204), the vector obtaining unit 112 ends the process shown in FIG. 7.

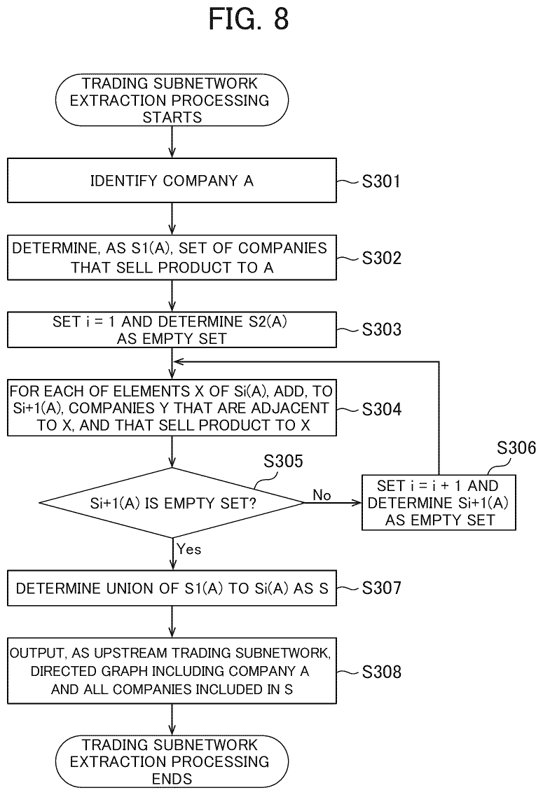

FIG. 8 is a flowchart showing a process for extracting a trading subnetwork, which corresponds to Step S202 in FIG. 7.

In Step S301, the vector obtaining unit 112 determines a specific company that is to be a basis for extracting a trading subnetwork. The specific company herein may be, for instance, a company corresponding to the vector-calculation target node selected in Step S202 in FIG. 7. For instance, a plurality of nodes included in the trading network are selected sequentially as vector-calculation target nodes, as shown in Steps S201 through S204 in FIG. 7. The specific company will be hereinafter referred to as a company A.

In Step S302, the vector obtaining unit 112 selects all companies X that are adjacent to the company A, corresponding to the vector-calculation target node, and that sells something to the company A, and the vector obtaining unit 112 determines a set of the selected companies X as S1(A).

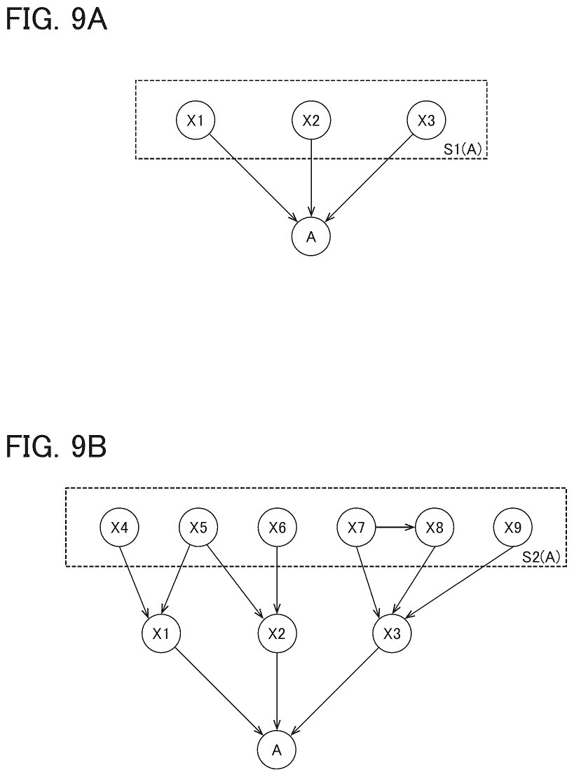

FIG. 9A illustrates S1(A) by way of example. For instance, FIG. 9A illustrates a trading network with a part including the company A being extracted. In the example in FIG. 9A, a node representing a company X1 is directly connected to a node representing the company A through an edge directed from X1 to A. That is, X1, which is a company that is adjacent to the company A and sells something to the company A, is determined as an element of S1(A). Likewise, X2 and X3, which are also companies that are adjacent to the company A and sell something to the company A, are determined as elements of S1(A). S1(A) in this case is a set of three elements X1, X2, and X3.

In Step S303, the vector obtaining unit 112 initializes a search variable i to 1 and determines Si+1(A) as an empty set. Here, i is initialized to 1, and Si+1(A) is thus S2(A). Accordingly, the vector obtaining unit 112 herein determines S2(A) as an empty set.

In Step S304, for each of the elements X of Si(A), the vector obtaining unit 112 adds, to Si+1(A), all companies Y that are adjacent to X and sell a product to X. When the processing in Step S304 is executed on a given company A for the first time, i=1 is established. Accordingly, in this case, for each of the elements X of S1(A), the vector obtaining unit 112 adds, to S2(A), all the companies Y that are adjacent to X and sell a product to X.

FIG. 9B illustrates S2(A) by way of example. S1(A) in this example is a set of three elements X1, X2, and X3, as earlier described with reference to FIG. 9A. The vector obtaining unit 112 firstly specifies a company Y that is adjacent to X1 and sells a product to X1. Here, two elements X4 and X5 satisfy this condition; thus, these two companies are added to S2(A). The vector obtaining unit 112 next specifies a company Y that is adjacent to X2 and sells a product to X2. Here, two elements X5 and X6 satisfy this condition. Since X5 has already been added to S2(A), X6 is added to S2(A). The vector obtaining unit 112 next specifies a company Y that is adjacent to X3 and sells a product to X3. Here, three elements X7, X8, and X9 satisfy this condition; thus, these three companies are added to S2(A). As a result, a set of six elements X4, X5, X6, X7, X8, and X9 is generated as S2(A) in Step S304 for instance, as illustrated in FIG. 9B.

In Step S305, the vector obtaining unit 112 determines whether Si+1(A) is an empty set. In the example in FIG. 9B, S2(A), which includes six elements, is determined as not being an empty set (NO in Step S305). In this case, the vector obtaining unit 112 in Step S306 increments the variable i to initialize Si+1(A) to an empty set. The process then goes back to Step S304. For instance, the vector obtaining unit 112 determines S2(A) as illustrated in FIG. 9B and then initializes S3(A) to an empty set in Step S306, followed by going back to the processing in Step S304.

In this case, the vector obtaining unit 112 in Step S304 specifies a company Y that is adjacent to a corresponding one of the elements X in S2(A) and sells a product to X, and the vector obtaining unit 112 adds the company Y to S3(A). For instance, the vector obtaining unit 112 specifies a company that is adjacent to X4 and sells a product to X4, and the vector obtaining unit 112 adds the specified company to S3(A). The same applies to X5 to X9; the vector obtaining unit 112 adds, to S3(A), a company that is adjacent to a corresponding one of the companies and sells a product to this company.

If S3(A) is not an empty set, the determination result in Step S305 is NO, and thus, the process goes back to Step S304 again to execute processing to determine S4(A). The succeeding processing is executed in a similar manner; until Si+1(A) becomes an empty set, the processing from Steps S304 through S306 is repeated.

That Si+1(A) is an empty set in Step S305 means that no element has been found that satisfies the condition as the result of the processing in Step S304. That is, none of the companies X, which are the elements of Si(A), has any more upstream company.

Thus, in this case (if YES in Step S305), the vector obtaining unit 112 in Step S307 sets a union of S1(A), S2(A), . . . , and Si(A) as S.

In Step S308, the vector obtaining unit 112 outputs, as a trading subnetwork, a directed graph including a node corresponding to the company A and nodes corresponding to all the companies included in S. The trading subnetwork, which is herein a subnetwork representing companies upstream of the company A corresponding to the vector-calculation target node, is also referred to as an upstream trading subnetwork.

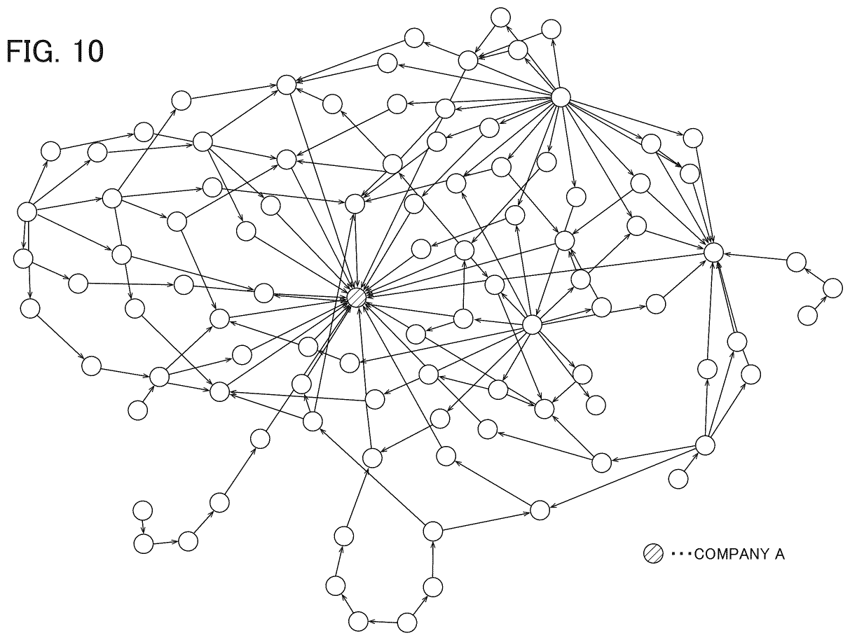

FIG. 10 illustrates an example of an upstream trading subnetwork. As illustrated in FIG. 10, the upstream trading subnetwork is a directed graph having nodes representing companies directly or indirectly connected to the company A. Doing so enables a portion related to a desired company to be extracted properly from a trading network. The upstream trading subnetwork, which constitutes information that enables specifying a relationship of connection with the company A, is useful information for representing a feature of the company A by the use of a complex vector.

It is noted that in determining Si+1(A) in Step S304, the vector obtaining unit 112 may specify the company Y in accordance with a condition, “the company Y is not included in a union of {A}, S1(A), . . . , and Si(A)” in addition to the condition “the company Y is adjacent to and sells something to the element X of Si(A)”.

For instance, reference is made to a case in which three companies Xa, Xb, and Xc exhibit a cycle of Xa←Xb←Xc←Xa, where Xa is an element of Si−2(A), Xb is an element of Si−1(A), and Xc is an element of Si(A). Here, “Xa←Xb” indicates that Xb is adjacent to and sells something to Xa. In this case, even though Xa is already an element of Si−2(A), Xa can be an element of Si+1(A) because it is adjacent to and sells something to Xc. That is, reflecting this cycle may complicate the processing executed by the vector obtaining unit 112. On that point, when the above condition “the company Y is not included in a union of {A}, S1(A), . . . , and Si(A)” is added, Xa is excluded from the elements of Si+1(A), thus enabling simplified processing.

Further, in Step S305 in FIG. 8, the vector obtaining unit 112 may determine whether i≥k is satisfied, in addition to whether Si+1(A) is an empty set. Herein, k is a value for determining the number of stages that undergo trading subnetwork extraction. Although k is a value of, for instance, about the numeral 3, a different value may be set. In response to satisfaction of at least one of a first condition: Si+1(A) is an empty set; and a second condition: i≥k is established, the vector obtaining unit 112 may determine NO in Step S305 and may then end a further search. Doing so can limit the number of upstream stages in a trading subnetwork for determining a vectorial representation to k stages. Consequently, a company that is distant from a company corresponding to a vector-calculation target node can be excluded from the processing, thereby enabling processing-load reduction. To be more specific, the number of elements whose values stand at 0 in their vectorial representations, which will be described later on, can be increased, thereby enabling calculation-load reduction in processing by the use of a complex vector (e.g., similarity calculation, and eigenvalue decomposition of the complex correlation matrix C).

It is noted that the foregoing has described an upstream trading subnetwork including companies upstream of the company A. Nevertheless, a trading subnetwork shall not be limited to an upstream trading subnetwork; the trading subnetwork may include a downstream trading subnetwork. For the downstream trading subnetwork, the processing, which is similar to that in FIG. 8 with the exception that the search direction is changed, will not be described. For instance, the vector obtaining unit 112 extracts a trading subnetwork of a vector-calculation target node in a range including k stages upstream of the vector-calculation target node and k stages downstream of the same.

### 2.3.2 Processing to Determine Vectorial Representation

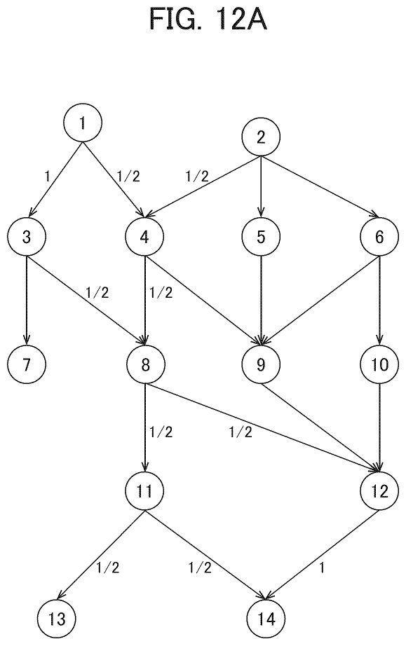

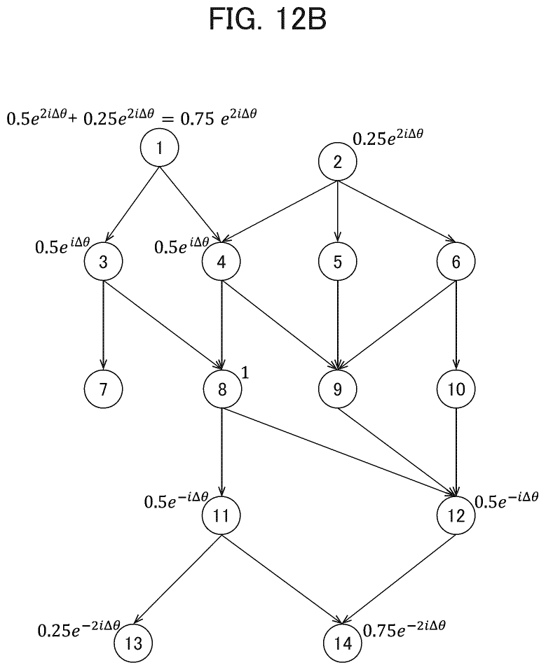

Processing to determine the vectorial representation of a vector-calculation target node in accordance with a trading subnetwork will be next described. In the technique in this embodiment, the vector obtaining unit 112 determines, for each node included in the trading subnetwork of the vector-calculation target node, a complex vector representing the vector-calculation target node by assigning a complex number having a phase corresponding to the distance to the vector-calculation target node, and having an absolute value corresponding to the amount of flow going to or coming from the vector-calculation target node. It is noted that the amount of flow in this embodiment is the amount of something that flows through a directed graph. The graph in this embodiment is a directed graph directed from upstream companies to downstream companies, and the amount of flow in this embodiment indicates degree at which the upstream companies influence the downstream companies. As will be described later on with reference to FIG. 12A, the amount of flow in this embodiment may be information determined based on a connection relationship between nodes in a directed graph. Alternatively, the amount of flow may be information reflecting, for instance, a specific quantity of a product (including materials, raw materials, a manufacturing apparatus, and other things) that is supplied from an upstream company to a downstream company.

The technique in this embodiment enables the amount of flow in a trading network (in a narrow sense, its trading subnetwork), which is a directed graph, to be represented by the use of an absolute value and also enables the distance between nodes to be represented by the use of a phase. This enables a vectorial representation reflecting accurately the structure of the trading subnetwork (local graph) including the vector-calculation target node. To be more specific, as the vectorial representation of a node, information can be used that reflects in detail information including which of the upstream companies and which of the downstream companies the node is connected to.

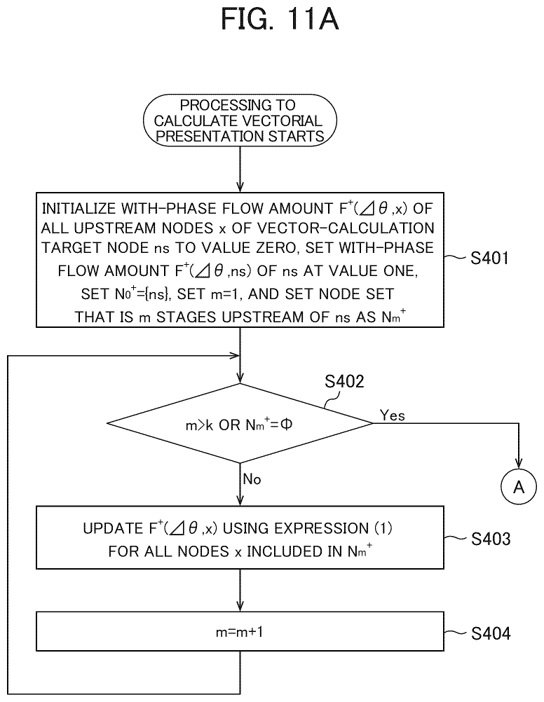

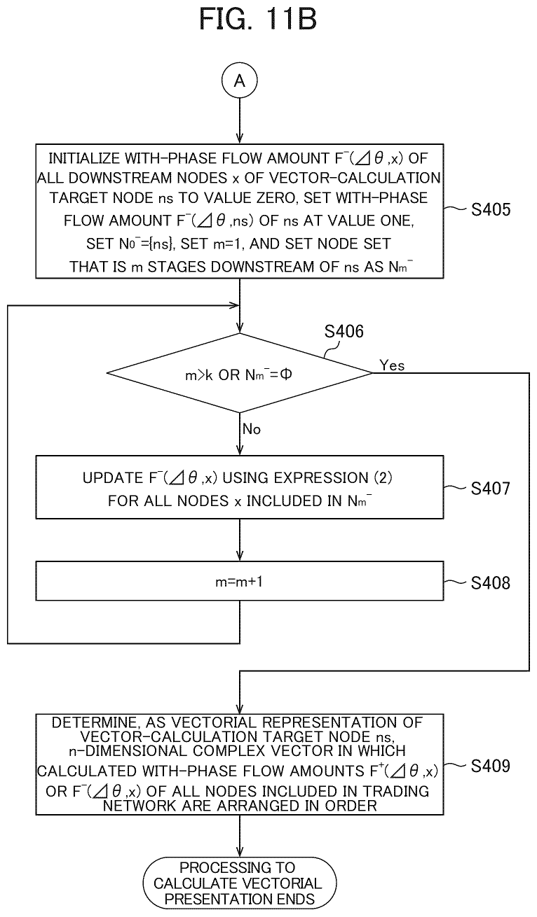

FIGS. 11A and 11B are flowcharts showing a process for determining the vectorial representation of a vector-calculation target node, which corresponds to Step S203 in FIG. 7. In Step S401, the vector obtaining unit 112 firstly executes initialization processing on an upstream node. In the following, let a node upstream of a vector-calculation target node ns be denoted as x; accordingly, the with-phase flow amount of the upstream node x is denoted as F⁺(Δθ, x). The vector obtaining unit 112 initializes F⁺(Δθ, x) to 0 for all upstream nodes x included in the trading network and located upstream of the vector-calculation target node ns. The vector obtaining unit 112 also sets F⁺(Δθ, ns), which is the with-phase flow amount of the vector-calculation target node ns itself, at 1. Further, let a node set that is m stages upstream of the vector-calculation target node be denoted as Nₘ⁺. A node that is zero stages away from the vector-calculation target node ns is the vector-calculation target node itself and is thus denoted as N₀⁺={ns}. The vector obtaining unit 112 also initializes m to 1.

In Step S402, the vector obtaining unit 112 determines whether at least one of m>k and Nₘ⁺=q is satisfied. Herein, k is similar to, for instance, k described in the processing to extract a trading subnetwork, and is a numeric value denoting the upper-limit number of stages in a search range. Further, φ denotes an empty set.

If m≤k and Nₘ⁺+q are satisfied (if NO in Step S402), the vector obtaining unit 112 in Step S403 updates F⁺(Δθ, x) using Expression (1) below for all nodes x included in Nₘ⁺.

$$\begin{matrix}[ Expression 1 ] & \\ & ( 1 )\end{matrix}$$

$${F}^{+} ( Δ θ , x ) = {F}^{+} ( Δ θ , x ) + {e}^{i Δ θ} \times \{ \sum \{ ratio of distribution to edge connecting x and y \times {F}^{+} ( Δ θ , y ) \} \} all nodes y connected to x in {N}_{m - 1}^{+}$$

Specific examples will be described with refence to FIGS. 12A and 12B. FIGS. 12A and 12B illustrate an instance where the trading network includes 14 nodes in total. Herein, let a node 8 be selected as a vector-calculation target node. It is noted that the trading network herein, which is small in scale and is identical to a trading subnetwork including three stages upstream of the node 8 and three stages downstream of the node 8, will not be distinguished from the trading subnetwork in the following description.

FIG. 12A illustrates the amount of flow in the trading network with a focus on the node 8. In this case, nodes that are one stage upstream of the node 8 are a node 3 and a node 4. That is, there are two edges for flow from a node one stage upstream of the node 8 into the node 8: one is the edge connecting the nodes 3 and 8 together, and the other is the edge connecting the nodes 4 and 8 together. Accordingly, when the amount of flow into the node 8 is set at 1, the amount of flow is distributed to the two edges at a given ratio.

At an equal distribution ratio for instance, the amount of flow from the node 3 into the node 8 stands at 1/2, and the amount of flow from the node 4 into the node 8 stands at 1/2. As a matter of course, when there are N edges (N is an integer equal to or greater than two) for flow from nodes one stage upstream of the node 8 into the node 8, the amounts of flow corresponding to the respective edges stand at 1/N. The following describes an instance where the ratio of distribution stands at an equal ratio. It is noted that when a specific product trading volume or other things is associated with an edge, the ratio of distribution may be set based on this trading volume.

Once the ratio of distribution is determined, the calculation in Expression (1) above is performed specifically. In determining F⁺(Δθ, 3) for instance, F⁺(Δθ, 3) in the first term on the right-hand side before update is an initial value per se and thus stands at 0. Further, N₀⁺ is only the node 8, and thus, the “all nodes y connected to x in Nₘ₋₁⁺” is the node 8. Further, the ratio of distribution of the edge connecting the nodes 3 and 8 together stands at 1/2, as earlier described. Further, F⁺(Δθ, y) denotes the with-phase flow amount of a vector-calculation target node, which is herein the node 8, and thus stands at 1 as set in Step S401. Accordingly, F⁺(Δθ, 3) is updated as below. Likewise, F⁺(Δθ, 4) is updated as below.

$${F}^{+} ( Δθ , 3 ) = 0 + {e}^{i Δ θ} \times ( 1 / 2 ) \times 1 = 0.5 {e}^{i Δ θ}$$

$${F}^{+} ( Δθ , 4 ) = 0 + {e}^{i Δ θ} \times ( 1 / 2 ) \times 1 = 0.5 {e}^{i Δ θ}$$

FIG. 12B illustrates an instance where a trading network similar to that in FIG. 12A is a target, and illustrates, by way of example, the with-phase flow amount of each node with the node 8 selected as a vector-calculation target node. As earlier described, the with-phase flow amounts of the nodes 3 and 4 both stand at 0.5e^{iΔθ}.

In Step S404, the vector obtaining unit 112 next increments m and goes back to Step S402 to execute the processing. For instance, m=2 is set in the processing in Step S402 for the second time; thus, a determination on whether 2>k is satisfied, and a determination on whether N₂⁺ is an empty set are made.

In k=3 for instance, 2>k is not satisfied. Further, in the examples in FIGS. 12A and 12B, there are two nodes that are two stages upstream of the node 8: one is a node 1, which is one stage upstream of and adjacent to the node 3, and one stage upstream of and adjacent to the node 4; and the other is a node 2, which is one stage upstream of and adjacent to the node 4. That is, N₂⁺ is not an empty set, but a set of the nodes 1 and 2. Thus, the vector obtaining unit 112 in this example determines NO in Step S402 and executes the processing in Step S403.

In this case, the nodes 1 and 2 included in N₂⁺ undergo update of their with-phase flow amounts. As illustrated in FIG. 12A, a node that is one stage upstream of the node 3 is only the node 1. That is, there is only one edge for flow from a node that is one stage upstream of the node 3 into the node 3: the edge connecting the nodes 1 and 3 together. Thus, the flow amount of the node 3 is, in its entirety, a flow amount derived from the node 1, and its ratio of distribution stands at 1.

Further, there are two nodes that are one stage upstream of the node 4: the nodes 1 and 2. That is, there are two edges for flow from nodes that are one stage upstream of the node 4 into the node 4: one is the edge connecting the nodes 1 and 4 together, and the other is the edge connecting the nodes 2 and 4 together. Thus, the flow amount of the node 4, which is a flow amount derived from the node 1 by half and from the node 2 by the remaining half, has a distribution ratio of 1/2 for each half.

Once the ratio of distribution is determined, the calculation in Expression (1) above is performed specifically. In determining F⁺(Δθ, 1) for instance, F⁺(Δθ, 1) in the first term on the right-hand side before update is an initial value per se and thus stands at 0. Further, N₁⁺ is the nodes 3 and 4, both of which are connected to the node 1; thus, the “all nodes y connected to x in Nₘ₋₁⁺” are two nodes, i.e., the nodes 3 and 4. Further, the ratio of distribution of the edge connecting the nodes 1 and 3 together stands at 1, and the with-phase flow amount F⁺(Δθ, 3) of the node 3 stands at, as earlier described, 0.5e^{iΔθ}. Further, the ratio of distribution of the edge connecting the nodes 1 and 4 together stands at 1/2, and the with-phase flow amount F⁺(Δθ, 4) of the node 4 stands at, as earlier described, 0.5e^{iΔθ}. Accordingly, F⁺(Δθ, 1) is updated as indicated below.

$${F}^{+} ( Δθ , 1 ) = 0 + {e}^{i Δ θ} \times \{ 1 \times 0.5 {e}^{i Δ θ} + 1 / 2 \times 0.5 {e}^{i Δ θ} \} = 0.75 {e}^{2 i Δ θ}$$

In determining F⁺(Δθ, 2), F⁺(Δθ, 2) in the first term on the right-hand side before update is an initial value per se and thus stands at 0. Further, N₁⁺ are the nodes 3 and 4, between which only the node 4 is connected to the node 2; thus, the “all nodes y connected to x in Nₘ₋₁⁺” is one node, i.e., the node 4. Further, the ratio of distribution of the edge connecting the nodes 2 and 4 together stands at 1/2, and the with-phase flow amount F⁺(Δθ, 4) of the node 4 stands at, as earlier described, 0.5e^{iΔθ}. Accordingly, F⁺(Δθ, 2) is updated as below.

$${F}^{+} ( Δθ , 2 ) = 0 + {e}^{i Δ θ} \times \{ 1 / 2 \times 0.5 {e}^{i Δ θ} \} = 0.25 {e}^{2 i Δ θ}$$

As can be seen from the above description, e^{iΔθ} undergoes multiplication every time the number of stages counted from the vector-calculation target node increases, and thus, the phase is shifted by Δθ every time. That is, in the technique in this embodiment, a node that is m stages upstream of a vector-calculation target node has a phase of mΔθ.

In Step S404, the vector obtaining unit 112 next increments m and goes back to Step S402 to execute the processing. For instance, m=3 is set in the processing in Step S402 in the third time; thus, a determination on whether 3>k is satisfied, and a determination on whether N₃⁺ is an empty set are made.

In the examples of the trading network in FIGS. 12A and 12B, there is no node that is upstream of the node 1 and is upstream of the node 2, and thus, N₃⁺ is an empty set. The vector obtaining unit 112 thus determines YES in Step S402 and proceeds to the processing on the downstream nodes shown in FIG. 11B. If N₃⁺ is not an empty set, and k≥3 is satisfied, the vector obtaining unit 112 determines NO in Step S402; accordingly, each node included in N₃⁺ undergoes update of its with-phase flow amount. That is, in the technique in this embodiment, the processing to update the with-phase flow amount is repeated toward upstream stages one by one until at least one of the following conditions is satisfied: k upstream stages have undergone the processing; and there is no more upstream node.

Upon completing the processing on the upstream nodes, the vector obtaining unit 112 in Step S405 in FIG. 11B executes initialization on downstream nodes. In the following, let a node downstream of the vector-calculation target node ns be denoted as x; accordingly, the with-phase flow amount of the downstream node x is denoted as F⁻(Δθ, x). The vector obtaining unit 112 initializes F⁻(Δθ, x) to 0 for all downstream nodes x included in the trading network and located downstream of the vector-calculation target node ns. The vector obtaining unit 112 also sets F⁻(Δθ, ns), which is the with-phase flow amount of the vector-calculation target node ns itself, at 1. Further, let a node set that is m stages downstream of the vector-calculation target node be denoted as Nₘ. A node that is zero stages away from the vector-calculation target node ns is the vector-calculation target node itself and is thus denoted as N₀⁻={ns}. The vector obtaining unit 112 also initializes m to 1.

In Step S406, the vector obtaining unit 112 determines whether at least one of m>k and Nₘ⁻=φ is satisfied. That is, like the processing on the upstream nodes, the processing is repeated on the downstream nodes until at least one of the following condition is satisfied: k downstream stages have undergone the processing; and there is no more downstream node.

If k stages have not yet undergone the processing, and there is a downstream node (if NO in Step S406), the vector obtaining unit 112 in Step S407 updates F⁻(Δθ, x) using Expression (2) below for all the nodes x included in Nₘ⁻.

$$\begin{matrix}[ Expression 2 ] & \\ & ( 2 )\end{matrix}$$

$${F}^{+} ( Δ θ , x ) = {F}^{+} ( Δ θ , x ) + {e}^{i Δ θ} \times \{ \sum \{ ratio of distribution to edge connecting x and y \times {F}^{-} ( Δ θ , y ) \} \} all nodes y connected to x in {N}_{m - 1}^{-}$$

In the example in FIG. 12A, nodes that are one stage downstream of the vector-calculation target node, i.e., the node 8, are a node 11 and a node 12. That is, there are two edges for flow from the node 8 into nodes that are one stage downstream of the node 8: one is the edge connecting the nodes 8 and 11 together, and the other is the edge connecting the nodes 8 and 12 together. Accordingly, when the amount of flow from the node 8 is set at 1, the amount of flow is distributed to the two edges at a given ratio. At an equal distribution ratio, the amount of flow from the node 8 into the node 11 stands at 1/2, and the amount of flow from the node 8 into the node 12 stands at 1/2.

Once the ratio of distribution is determined, the calculation in Expression (2) above is performed specifically. In determining F⁻(Δθ, 11) for instance, F⁻(Δθ, 11) in the first term on the right-hand side before update is an initial value per se and thus stands at 0. Further, N₀ is only the node 8, and thus, the “all nodes y connected to x in Nₘ₋₁⁻” is the node 8. Further, the ratio of distribution of the edge connecting the nodes 8 and 11 together stands at 1/2, as earlier described. Further, F⁻(Δθ, y) denotes the with-phase flow amount of the vector-calculation target node, i.e., the node 8, and thus stands at 1 as set in Step S405. Accordingly, F⁻(Δθ, 11) is updated as below. Likewise, F⁻(Δθ, 12) is updated as below.

$${F}^{-} ( Δθ , 11 ) = 0 + {e}^{- i Δ θ} \times ( 1 / 2 ) \times 1 = 0.5 {e}^{- i Δ θ}$$

$${F}^{-} ( Δθ , 12 ) = 0 + {e}^{- i Δ θ} \times ( 1 / 2 ) \times 1 = 0.5 {e}^{- i Δ θ}$$

In Step S408, the vector obtaining unit 112 next increments m and goes back to Step S406 to execute the processing. For instance, m=2 is set in the processing in Step S406 in the second time; thus, a determination on whether 2>k is satisfied, and a determination on whether N₂⁻ is an empty set are made.

In the examples in FIGS. 12A and 12B, the nodes 13 and 14 included in N₂⁻ undergo the processing to update F⁻(Δθ, 13) and F⁻(Δθ, 14). The detailed processing, which is similar to the example described earlier, will not be described. It is noted that e^{-iΔθ} undergoes multiplication every time the number of stages counted from the vector-calculation target node increases, and thus, the phase is shifted by −Δθ every time. That is, in the technique in this embodiment, a node that is m stages downstream of the vector-calculation target node has a phase of −mΔθ.

If at least one of the following conditions: k downstream stages have undergone the processing; and there is no more downstream node, is satisfied (if YES in Step S406), the vector obtaining unit 112 in Step S409 determines the vectorial representation of the vector-calculation target node in accordance with the with-phase flow amount determined for each node.

To be specific, the vector obtaining unit 112 determines, as the vectorial representation of the vector-calculation target node, an n-dimensional complex vector in which the with-phase flow amounts of all n nodes included in the trading network are arranged in a predetermined order.

FIG. 13 illustrates a vectorial representation in the examples described earlier with reference to FIGS. 12A and 12B. As earlier described, the trading network herein includes 14 nodes, and a determined vector is a 14-dimensional complex vector. The 14-dimensional complex vector is, for instance, a vector in which the with-phase flow amounts of the nodes 1 to 14 are arranged in the stated order. It is noted that the order of a plurality of nodes included in the trading network is non-limiting; modifications can be made in various manners.

As earlier described, the nodes 1 to 4 and nodes 11 to 14 are connected to the node 8, which is a vector-calculation target node, and thus, these nodes undergo update of their with-phase flow amounts. Thus, the first to fourth elements and the eleventh to fourteenth elements are complex numbers that are not zero. In contrast, the nodes 5 to 7 and nodes 9 to 10 are not targets for update, and thus, their with-phase flow amounts remain at an initial value, i.e., 0. Thus, the fifth to seventh elements and the ninth to tenth elements stand at 0. The eighth element, which is the with-phase flow amount of the node 8 itself, stands at 1.

The technique in this embodiment enables not only the use of a flow amount per se, but also the use of a vectorial representation reflecting the number of stages counted from a vector-calculation target node. In the example in FIG. 13, since the first element of the complex vector has a phase of 2Δθ, this complex vector can hold information indicating that the node 1 is two stages upstream of the vector-calculation target node. Likewise, since the third element has a phase of Δθ, the complex vector can hold information indicating that the node 3 is one stage upstream of the vector-calculation target node. By using the complex vector holding these information items in the subsequent processing, information including the number of stages is reflected to the processing, thereby enabling improvement in processing accuracy.

It is noted that in performing the processing on up to k upstream and downstream stages, the phases of a complex number constituting elements are Δθ, 2Δθ, 3Δθ, . . . , and kΔθ at the upstream stages and are −Δθ, −2Δθ, −3Δθ, . . . , and −kΔθ at the downstream stages. To clarify the relationship between phases and the number of stages, these phases do not desirably overlap each other. For instance, when k=3 is satisfied, setting Δθ=π/2 involves an overlap, such as e^{2iΔθ}=e^{-2iΔθ}=−1, thus making it difficult to distinguish, for instance, that a node is two stages upstream away from that the node is two stages downstream away. Accordingly, the value Δθ in this embodiment may be set based on k. For instance, Δθ is a positive real number satisfying (k+1)×Δθ=π.

FIG. 14 illustrates part of a trading network of different structure. FIG. 14 shows an instance where the node 1 is selected as a vector-calculation target node, and where the with-phase flow amounts of the nodes 2 to 5 and other nodes are determined.

Here, the node 5, which is directly connected to the node 1, is a node included in Nit. To be specific, the with-phase flow amount F⁺(Δθ, 5) of the node 5 is updated as below through processing targeted on N₁⁺.

$${F}^{+} ( Δθ , 5 ) = 0 + {e}^{i Δ θ} \times ( 1 / 3 ) \times 1 = ( 1 / 3 ) {e}^{i Δ θ}$$

The node 5, which is one stage upstream of the node 2 included in Nit, is also a node included in N₂⁺. To be specific, the with-phase flow amount F⁺(Δθ, 5) of the node 5 is updated as below through processing targeted on N₂⁺. It is noted that the with-phase flow amount F⁺(Δθ, 2) of the node 2 is (⅓) e^{iΔθ}

$${F}^{+} ( Δθ , 5 ) = ( 1 / 3 ) {e}^{i Δ θ} + {e}^{i Δ θ} \times ( 1 / 2 ) \times ( 1 / 3 ) {e}^{i Δ θ} = ( 1 / 3 ) {e}^{i Δ θ} + ( 1 / 6 ) {e}^{2 i Δ θ}$$

Furthermore, the node 5, which is one stage upstream of the node 4 included in N₂⁺, is a node included in N₃⁺. To be specific, the with-phase flow amount F⁺(Δθ, 5) of the node 5 is updated as below through processing targeted on N₃⁺. It is noted that the with-phase flow amount F⁺(Δθ, 4) of the node 4 is (⅙) e^{2iΔθ}.

$${F}^{+} ( Δθ , 5 ) = ( 1 / 3 ) {e}^{i Δ θ} + ( 1 / 6 ) {e}^{2 i Δ θ} + {e}^{i Δ θ} \times ( 1 / 2 ) \times ( 1 / 6 ) {e}^{2 i Δ θ} = ( 1 / 3 ) {e}^{i Δ θ} + ( 1 / 6 ) {e}^{2 i Δ θ} + ( 1 / 12 ) {e}^{3 i Δ θ}$$

As described above, the technique in this embodiment enables representing, by using the with-phase flow amount of a target node, a network structure in which there are multiple paths having different distances (the number of stages) measured from a vector-calculation target node to the target node. In the foregoing example for instance, F⁺(Δθ, 5) includes three phase terms, i.e., Δθ, 2Δθ, and 3Δθ; thus, the structure of the trading subnetwork illustrated in FIG. 14 is reflected appropriately to a vectorial representation.

The complex vector of each node in the trading network may be used, for instance, in similarity calculation between the nodes. For instance, the processing unit 110 may include a similarity calculating unit (not shown) that determines the similarity, S, between nodes i and j on the basis of Expression (3) below. In Expression (3) below, xⱼ* denotes a complex conjugate vector with conjugate complex numbers taken from individual elements of xⱼ. That is, the numerator on the right-hand side denotes the Hermitian inner product of xᵢ and xⱼ. Further, |xᵢ| and |xⱼ| respectively denote the sizes (norms) of xᵢ and xⱼ. R{ } denotes a real part.

$$\begin{matrix}[ Expression 3 ] & \\ S = R \{ \frac{{x}_{i} \cdot \text{?}}{\vert {x}_{i} \vert \vert {x}_{j} \vert} \} & ( 3 )\end{matrix}$$

$$\text{?} \text{indicates text missing or illegible when filed}$$

Doing so enables cosine similarity that is used in, for instance, similarity calculation between vectors, to be extended to a complex number. To be specific, a determination by the use of the distance (phase difference) between nodes can be made, as earlier described, thereby enabling similarity calculation with high accuracy.

### 2.4 Complex Correlation Matrix and Eigenvalue Decomposition

The complex vector according to this embodiment may be used in processing to extract a supply chain network from a trading network. To be specific, as shown in Step S103 in FIG. 4, the matrix obtaining unit 113 determines the complex correlation matrix C on the basis of the complex vector, and as shown in Step S104, the matrix obtaining unit 113 subjects the complex correlation matrix C to eigenvalue decomposition.

The matrix obtaining unit 113 firstly obtains the complex vectorial representation of each of first to n-th nodes included in the trading network. Hereinafter, a complex vector corresponding to the i-th (i is an integer satisfying 1≤i≤n) node will be denoted as xᵢ. For instance, the vector obtaining unit 112 selects each of the first to n-th nodes as a vector-calculation target node and subjects them individually to the processing shown in FIGS. 11A and 11B to thus determine complex vectors x₁ to xₙ, and the vector obtaining unit 112 stores the determined x₁ to xₙ in the storage unit 120. Each of x₁ to xₙ is an n-dimensional complex vector; for instance, each is a column vector.

The matrix obtaining unit 113 next arranges x₁ to xₙ to obtain a matrix X. For instance, the matrix obtaining unit 113 obtains the matrix X=[x₁, x₂, . . . , xₙ], in which x₁ to xₙ are arranged in a predetermined order, and normalizes each component such that its absolute value stands at 1. The matrix obtaining unit 113 then sets the matrix after the normalization anew as a matrix X. As described above, the processing of “arranging x₁ to xₙ to obtain a matrix X” in this embodiment is not limited to merely arranging x₁ to xₙ; this processing may include other kinds of processing (the processing may be pre-arrangement processing, or post-arrangement processing), such as normalization.

The matrix X is a square matrix of n rows and n columns. The matrix obtaining unit 113 also determines a matrix (complex conjugate transposition) X* in which conjugate complex numbers of the individual components of the matrix X are transposed. The matrix X* is a square matrix of n rows and n columns as well. It is noted that the order of arrangement of n nodes included in the trading network is the same as the order in determining the complex vectorial representation.

The matrix obtaining unit 113 then determines the complex correlation matrix C through C=XX*. The complex correlation matrix C is a square matrix of n rows and n columns as well. Each component of C corresponds to the Hermitian inner product of two complex vectors and is thus information corresponding to the similarity expressed by Expression (3) above. Thus, C can be used as the complex correlation matrix C indicating the node-to-node correlation between the first to n-th nodes in the trading network.

The matrix obtaining unit 113 next subjects the complex correlation matrix C to eigenvalue decomposition. To be specific, the matrix obtaining unit 113 decomposes, through C=VΛV⁻¹, the complex correlation matrix C into the following: a matrix V with its eigenvector as a column vector; and a diagonal matrix Λ with its eigenvalue as a diagonal component. Hereinafter, m eigenvalues will be denoted as e₁ to eₘ, and m eigenvectors corresponding to the respective eigenvalues will be denoted as v₁ to vₘ. Here, m is an integer satisfying m≤n. Since eigenvalue decomposition is a known method, its detailed description will be omitted.

It is noted that although the foregoing has described an instance where x₁ to xₙ are represented as column vectors, x₁ to xₙ may be represented as row vectors. In this case, for instance, the matrix obtaining unit 113 sets, as X, a matrix in which x₁ to xₙ are longitudinally arranged, and in which their absolute values are normalized to 1. Further, the matrix obtaining unit 113 may determine the complex correlation matrix C through C=X*X. As described above, the matrix obtaining unit 113 according to this embodiment performs processing to determine the complex correlation matrix C from a plurality of complex vectors, which represent respective nodes in a trading network, and processing to subject the complex correlation matrix C to eigenvalue decomposition. Their specific processing can be modified in various manners.

### 2.5 Obtainment of Supply Chain Network

Processing to extract a supply chain network, which corresponds to Step S105 in FIG. 4, will be next described.

The network extracting unit 114 performs processing to extract a supply-chain-network group in accordance a trading network and complex vectors, and processing to select a part of the supply-chain-network group including a reference node corresponding to an entity of interest, as a supply chain network that is a target for priority-path selection. Doing so enables an important part of the trading network to be extracted as a supply chain network and enables processing targeted on a specific node (company) to be performed. This can appropriately prevent the volume of information that is used in the priority-path selection.

Hereinafter, processing to extract a supply-chain-network group without company (node) limitations will be referred to as first extraction processing, and processing to extract a supply chain network from the supply-chain-network group with limitations on companies or other things will be referred to as second extraction processing.

### 2.5.1 Obtainment of Supply-Chain-Network Group

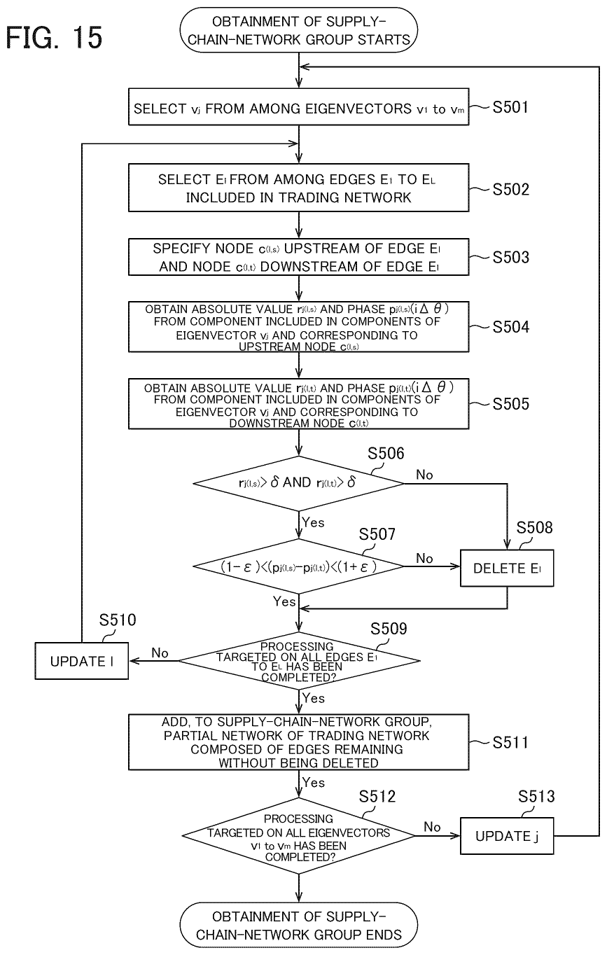

FIG. 15 is a flowchart showing the first extraction processing that is performed by the network extracting unit 114. In Step S501, the network extracting unit 114 firstly selects vⱼ from among m eigenvectors v₁ to vₘ. Here, j is an integer of 1 to m inclusive, and for example, its initial value is expressed as j=1.

Here, v₁ is a vector obtained by subjecting the complex correlation matrix C of n rows and n columns to eigenvalue decomposition, and is thus a column vector including n elements. For example, the eigenvector vⱼ is expressed as Expression (4) below. It is noted that for easy expression, Expression (4) below uses a transposition expression of the eigenvector vⱼ.

$$\begin{matrix}[ Expression 4 ] & \\ {v}_{j}^{T} = ( {r}_{j 1} \text{?} , {r}_{j 2} \text{?} , … , {r}_{jN} \text{?} ) & ( 4 )\end{matrix}$$

$$\text{?} \text{indicates text missing or illegible when filed}$$

Here, the first element of the eigenvector vⱼ indicates information about the node 1 in the trading network. That is, the node 1 has an absolute value (a flow amount) of rⱼ₁, and a phase (a distance from a reference node) of pⱼ₁. The same holds true for the second to n-th elements of the eigenvector vⱼ; each exhibits the flow amount and phase of a corresponding one of the nodes 2 to n. That is, a single eigenvector is information for specifying the relationship (network structure) between n nodes included in the trading network. Moreover, in view that eigenvectors are determined from the complex correlation matrix C, a network structure represented by the eigenvectors is conceivably a main network structure in the trading network. As such, the network extracting unit 114 according to this embodiment performs the first extraction processing to extract the supply-chain-network group from the trading network in accordance with the eigenvectors.

In Step S502, the network extracting unit 114 selects E₁ from among edges E₁ to E_{L} (L denotes the total number of edges and is an integer equal to or greater than two) included in the trading network. Here, 1 is an integer of 1 to L inclusive, and for example, its initial value is expressed as 1=1.

In Step S503, the network extracting unit 114 specifies a node c_{(1, s)} upstream of the edge E₁ and a node c_{(1, t)} downstream of the edge E₁. The edge E₁ includes, for instance, the upstream node c_{(1, s)} and downstream node c_{(1, t)} as its attribute; by referring to these attribute values, the network extracting unit 114 performs the processing in Step S503.

In Step S504, the network extracting unit 114 determines the absolute value, r_{j(1, s)}, and phase, p_{j(1, s)}, of the upstream node c_{(1, s)} in accordance with the eigenvector vⱼ. To be specific, the network extracting unit 114 specifies in what position the upstream node c_{(1, s)} is placed among the nodes 1 to n included in the trading network, and the network extracting unit 114 reads a corresponding one of n elements of the eigenvector vⱼ to determine the absolute value r_{j(1, s)} and the phase p_{j(1, s)}. For example, when the upstream node c_{(1, s)} corresponds to the node 1, r_{j(1, s)}=rⱼ₁ is established, and p_{j(1, s)}=Pⱼ₁ is established.

In Step S505, the network extracting unit 114 determines the absolute value, r_{j(1, t)}, and phase, p_{j(1, t)}, of the downstream node c_{(1, t)} in accordance with the eigenvector vⱼ. The specific processing is similar to that in the upstream node c_{(1, s)}.

The network extracting unit 114 then extracts the supply chain network by performing the following: first determination to determine the size of the flow amount of the upstream node c_{(1, s)}, and the size of the flow amount of the downstream node c_{(1, t)}, both of which are denoted by the absolute values of the elements of the eigenvector v₁; and second determination to determine the distance between the upstream node c_{(1, s)} and downstream node c_{(1, t)}, which is denoted by the phases of the elements of the eigenvector vⱼ. It is noted that both of the first determination and second determination are not essential; either one of them may be omitted.

In this way, the degree of importance of the edge E₁ can be determined by the use of the flow amount and phase, both of which are determined from the eigenvector vⱼ. To be specific, when both of the flow amount of the upstream node c_{(1, s)} and the flow amount of the downstream node c_{(1, t)} are large to a certain extent in an eigenvector, the edge E₁ connecting these two nodes together is presumably an important edge in the trading network. Further, the phase determined from the eigenvector vⱼ indicates the main connection relationship (distance, the number of stages) between the upstream node c_{(1, s)} and downstream node c_{(1, t)} in the network structure represented by this eigenvector vⱼ. That is, the importance of the edge E₁ can be determined as being high if a connection relationship specified from the phase of an eigenvector, and the connection relationship in the edge E₁ are close to each other, and the importance of the edge E₁ can be determined as being low if these relationships are far from each other. As described above, using a flow amount and a phase can make an appropriate determination on the edge E₁.

In Step S506, the network extracting unit 114 performs the first determination based on the flow amount. To be specific, the network extracting unit 114 determines whether the absolute value r_{j(1, s)} of the upstream node c_{(1, s)} is greater than a given threshold δ, and whether the absolute value r_{j(1, t)} of the downstream node c_{(1, t)} is greater than the given threshold δ.

If both of r_{j(1, s)} and r_{j(1, t)} are greater than 8 (if YES in Step S506), the network extracting unit 114 in Step S507 performs the second determination based on the phase (distance). To be specific, the network extracting unit 114 subtracts the phase p_{j(1, t)} of the downstream node c_{(1, t)} from the phase p_{j(1, s)} of the upstream node c_{(1, s)} and determines whether the subtracted value is greater than 1−ε and smaller than 1+ε. Here, ε denotes a given threshold.

The numeral value 1 included in 1+ε and 1−ε is a value denoting the distance between two adjacent nodes. As described above, the upstream node c_{(1, s)} and downstream node c_{(1, t)} in the trading network are two nodes directly connected together by the edge E₁, and their node-to-node distance stands at 1. That is, when the edge E is an important edge in the trading network, it is presumed that the upstream node c_{(1, s)} and downstream node c_{(1, t)} are directly connected together by an edge corresponding to the edge E₁, that is, their node-to-node distance, determined from the eigenvector vⱼ, stands at a value that is sufficiently close to 1, even in a network structure represented by the eigenvector vⱼ. On the other hand, when the edge E₁ is not an important edge in the trading network, it is presumed, in the network structure represented by the eigenvector vⱼ, that the upstream node c_{(1, s)} and downstream node c_{(1, t)} are not connected together in the first place, or that their node-to-node distance stands at a value that is different from 1 as the result of their connection by an edge that is different from the edge E₁.

As such, in Step S507, the network extracting unit 114 determines a difference value between the distance between the upstream node c_{(1, s)} and downstream node c_{(1, t)} determined from the eigenvector vⱼ, and the distance (to be specific, 1) between two adjacent nodes. Accordingly, the importance of the edge E₁ can be appropriately determined based on the phase.

If at least one of the flow amounts is equal to or smaller than the threshold δ (if NO in Step S506), or if the absolute value of the difference between the distance and the numeral value 1 is equal to or greater than ε (if NO in Step S507), the importance of the edge E₁, which is a processing target, is determined as being low. Accordingly, in Step S508, the network extracting unit 114 performs processing to exclude E₁ from the supply chain network that is an extraction target.

On the other hand, if both of the flow amounts are greater than the threshold δ (if YES in Step 506), and if the absolute value of the difference between the distance and the value 1 is smaller than ε (if YES in Step 507), the edge E₁ is left as an edge constituting the supply chain network.

The processing targeted on the edge E₁ is thus completed. In Step S509, the network extracting unit 114 determines whether the processing targeted on all the edges E₁ to E_{L} included in the trading network has been completed.

If there is an unprocessed edge (if NO in Step S509), the network extracting unit 114 in Step S510 updates the variable 1 and then goes back to Step S502. For instance, the network extracting unit 114 subjects the edge E₁ to the processing, followed by incrementing the variable 1 to update the variable 1 to 2, followed by subjecting the edge E₂ to the foregoing processing in Steps S502 to S509.

If the processing targeted on all the edges has been completed (if YES in Step S509), the network extracting unit 114 in Step S511 adds a network including some of the edges E₁ to E_{L} remaining without being excluded in the processing in Step S508, to the supply-chain-network group. The network that is added herein is a partial network of the trading network. It is noted that the network including some of the edges E₁ to E_{L} remaining without being excluded in the processing in Step S508 does not necessarily constitute a graph in which all nodes are connected together; this network may be divided into several networks. The network extracting unit 114 in this case performs processing to add the individual divided networks to the supply-chain-network group.

Through the processing in Steps S501 to S511, the extraction of the supply chain network targeted on the eigenvector vⱼ is completed. In Step S512, the network extracting unit 114 next determines whether the processing targeted on all the eigenvectors v₁ to vₘ determined through eigenvalue decomposition has been completed.

If there is an unprocessed eigenvector (if NO in Step S512), the network extracting unit 114 in Step S513 updates the variable j and then goes back to Step S501. For instance, the network extracting unit 114 subjects the eigenvector v₁ to the processing, followed by incrementing the variable j to update the variable j to 2, followed by subjecting the eigenvector v₂ to the foregoing processing in Steps S502 to S513. It is noted that when an eigenvector that is to be processed undergoes update, the processing result in Step S508 undergoes initialization as well, and the processing in Step S502 is started again with all of the edges E₁ to E_{L} unremoved.

If the processing targeted on all the eigenvectors has been completed (if YES in Step S512), the network extracting unit 114 ends the first extraction processing to extract the supply-chain-network group. That is, the supply-chain-network group is a set of partial networks determined for the respective eigenvectors v₁ to vₘ.

### 2.5.2 Selection of Supply Chain Network

The network extracting unit 114 next performs the second extraction processing to extract a supply chain network related to a particular company from the supply-chain-network group. For instance, the network extracting unit 114 extracts a supply chain network including a node corresponding to a given company from the supply-chain-network group determined through the first extraction processing shown in FIG. 15. Here, the given company may be input using the operation unit 250 of the terminal device 200. For instance, the user of the terminal device 200 performs an operation to select a company of interest that requires some kind of analysis, such as his/her company itself, a competitor, or a company to be bought out. The network extracting unit 114 performs the second extraction processing by specifying a node corresponding to the selected company, and extracting a network including the specified node from among the networks included in the supply-chain-network group.

Further, the network extracting unit 114 may narrow down supply chain networks on the basis of another condition. For instance, the network extracting unit 114 may select a supply chain network related to a particular product of the company of interest. The network extracting unit 114 in this case may determine whether information indicating the selected product is included in a tag provided to an edge in the supply-chain-network group.

### 2.6 Determination of Priority Path

Processing that is performed by the path selecting unit 115 will be next described. The following is an instance where, as earlier described, the information processing system 10 includes the network extracting unit 114 that extracts the second network 122 from the first network 121. The path selecting unit 115 in this case may determine a priority path from the second network 122. With the second network 122 as a target, an important part of the first network 121 can undergo priority-path selection. When the second network 122 is a supply chain network, a trading path can be determined that is highly important in an essential trading relationship of an entity of interest.

### 2.6.1 Process Flow

The nodes in the entity network according to this embodiment may be provided with additional data that is a tag including one or more of a plurality of tag values. Moreover, the path selecting unit 115 may determine, as the feature amount, a path weight and a tag-transition-pattern weight; here, the path weight indicates the weight of each of the plurality of paths, and the tag-transition-pattern weight is the weight of a tag transition pattern indicating how the one or more tag values transition when the node transitions along the path. The path selecting unit 115 may then select a priority path based on the path weight and the tag-transition-pattern weight. Doing so can select a priority path that reflects both a path weight reflecting node-to-node connection relationship and a tag-transition-pattern-weight reflecting tag value transition.

The tags according to this embodiment may be information indicating at least one of an industrial classification and a country. For a tag value indicating an industrial classification for example, the tag transition pattern is information indicating how the industrial classification changes on a path connecting companies together. In this case, using the tag-transition-pattern weight can specify an important path (main trading path) from the viewpoint that in what kind of industrial classification companies have a relationship.

Further, for a tag value indicating a country, using the tag-transition-pattern weight can determine that in which country companies have a relationship. As a result, a priority path can be selected that reflects, for instance, a relationship between countries. For example, when a path including companies belonging to a specific country is selected as a priority path in a supply chain network of a certain commodity, it is possible to determine that dependence on the specific country is probably high.

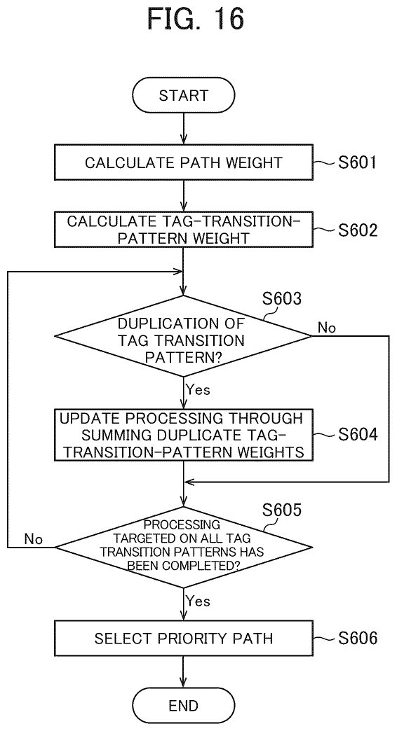

FIG. 16 is a flowchart showing a process for selecting a priority path, which corresponds to in Step S106 in FIG. 4. In Step S601, the path feature amount unit 115 firstly determines a path weight, which is a feature amount indicating a path weight, for each of a plurality of paths included in the second network 122.

In Step S602, the path selecting unit 115 determines, for each of the plurality of paths, a tag transition pattern indicating how tag values, each of which is additional data provided to a node, change along the path. The path selecting unit 115 then sets the path weight of the path as a tag-transition-pattern weight indicating the weight of the tag transition pattern corresponding to a processing target path.

In Step S603, the path selecting unit 115 selects a single tag transition pattern and determines whether the tag transition pattern coincides with the tag transition pattern of another path. If the tag-transition-pattern weight coincides with that of the other path (if YES in Step S603), the path selecting unit 115 in Step S604 updates the tag-transition-pattern weight by summing the tag-transition-pattern weights determined from the respective paths. If the tag transition pattern does not coincide (if NO in Step S603), the processing in Step S604 is omitted. That is, for a tag transition pattern that does not coincide with that of another path, the weight set in Step S602 is used as is, as the tag-transition-pattern weight.

In Step S605, the path selecting unit 115 determines whether the processing has been performed on all the tag transition patterns. If there is a tag transition pattern remaining unprocessed (if NO in Step S605), the path selecting unit 115 returns to Step S603 to continue the processing.

If the processing has been performed on all the tag transition patterns (if YES in Step S605), the path selecting unit 115 in Step S606 selects a priority path based on the path weight and tag-transition-pattern weight. The following details processing in each step by using a specific example.

### 2.6.2 Path Weight

First, processing to calculate a path weight, which corresponds to Step S601 in FIG. 16, will be described. The path selecting unit 115 may determine, for each of a plurality of paths included in an entity network, a path weight based on a trading relationship or a control relationship of a node on the path. Doing so enables a path weight calculation based on a specific configuration of the entity network.

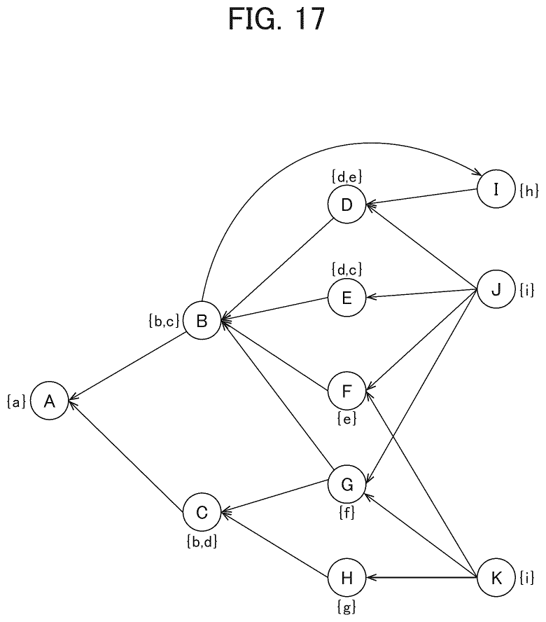

FIG. 17 illustrates an example of a supply chain network that is the second network 122 to be subjected to priority path selection. The following describes a supply chain network of simple configuration including 11 nodes: nodes A to K. In FIG. 17, the tags provided to the individual nodes are illustrated with the symbol { }. The lower-case alphabets a to i denote exemplary tag values (attribute values) included in the tags; here, a single alphabet denotes a single industrial classification. For instance, the node A is associated with the alphabet a as an industrial classification. Further, a single company runs multiple business enterprises in some cases; thus, a single node may be associated with a plurality of industrial classifications. For instance, the node B is associated with the alphabets b and c as industrial classifications. The same holds true for the nodes C to K, each of which is provided with a tag including one or more industrial classifications.

The supply chain network illustrated in FIG. 17 has a path A→B→D→I, the order of which is the inverse of the arrows on the drawing sheet. Hereinafter, a path on which a plurality of nodes are connected together will be simply represented by a row of alphabets denoting nodes. For instance, a path ABDI represents a path passing through the nodes A, B, D, and I in the stated order. The supply chain network in FIG. 17 has an edge directed from the node B to the node I and thus has a path IB, the order of which is the inverse of the arrow on the drawing sheet. The supply chain network thus includes an infinite loop ABDIBDIB . . . .

When such a loop is included in the second network 122, the loop may be removed before the path selecting unit 115 selects a priority path. For instance, the information processing system 10 may include a network updating unit (not shown in FIG. 2) that updates the second network 122 by removing a loop included in the second network 122. The network updating unit is included in, for instance, the processing unit 110 of the server system 100. To be specific, the network updating unit eliminates the edge between the nodes I and B, constituting a loop, in view of the path ABDI immediately before a loop being reflected. This can prevent calculation load in the priority path calculation. When focusing on the flow of goods, based on findings that a loop appearing in a supply chain network does not have to be considered as an essential part (e.g., Kichikawa, Y., Iyetomi, H., Iino, T. et al. Community structure based on circular flow in a large-scale transaction network. Appl Netw Sci 4, 92 (2019). https://doi.org/10.1007/s41109-019-0202-8), it is possible to execute appropriate processing even if a loop is removed.

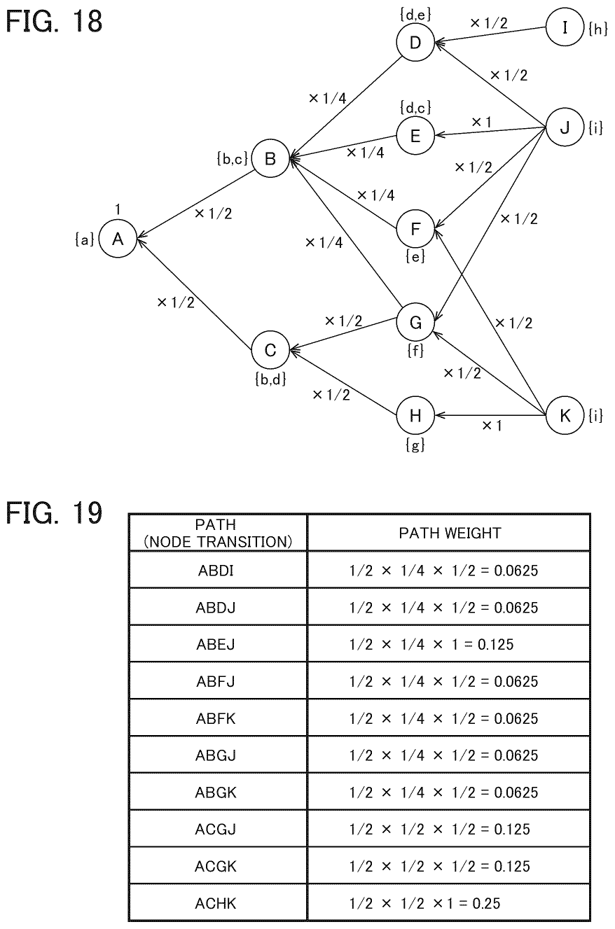

FIG. 18 illustrates the supply chain network in FIG. 17 with the loop removed and with the weight at each edge added. For instance, in the supply chain network in FIG. 18, the node A is a downstream end, and the nodes I, J, and K are upstream ends.

There is one path of transition from the node A to the node I: ABDI. There are five paths of transition from the node A to the node J: ABDJ, ABEJ, ABFJ, ABGJ, and ACGJ. There are four paths of transition from the node A to the node K: ABFK, ABGK, ACGK, and ACHK. The supply chain network illustrated in FIG. 18 has ten paths as listed above.

The path selecting unit 115 determines a path weight for each of these paths. FIG. 19 is a table showing examples of a weight based on the structure of a supply chain network, that is, examples of a path weight determined based on a flow amount. When the flow amount of the node A is set at 1 for instance, the node A is connected to the nodes B and C. When the flow amount is divided into equal amounts, the flow amount of the node B stands at 0.5, which is a half of the flow amount of the node A, i.e., 1. Likewise, the flow amount of the node C also stands at 0.5.

Further, the node B is connected to the node D, node E, node F, and node G. Thus, the flow amount of the node B, i.e., 0.5 is distributed to these four nodes. Accordingly, the flow amount of each node stands at 0.5×(¼)=0.125.

Further, the node D is connected to the node I and node J. Thus, the flow amount of the node D, i.e., 0.125 is distributed to these two nodes. Accordingly, the weight (flow amount) at the end node I along a node transition, the path ABDI, stands at 0.125×(½)=0.0625. The path selecting unit 115 sets the weight at the terminal node of a path as the weight of the path. Likewise, the weight of the end node J along the path ABDJ stands at 0.0625, and thus, the weight of the path ABDJ stands at 0.0625 as well.

The same holds true for the other paths. For instance, the node E is connected to only the node J, and thus, the weight of the path ABEJ stands at 0.125, which is the same as the flow amount at the node E.

The node F is connected to the node J and node K. Thus, the weight of the path ABFJ and the weight of the path ABFK stand at 0.0625 each, which is a half of the flow amount of the node F.

The node G is connected to the node J and node K. Thus, the weight of the path ABGJ and the weight of the path ABGK stand at 0.0625 each, which is a half of the flow amount of the node G passed through the node B. Further, the weight of the path ACGJ and the weight of the path ACGK stand at 0.125 each, which is a half of the flow amount of the node G passed through the node C.

The node His connected to the node K only. Thus, the weight of the path ACHK stands at 0.25, which is the same as the flow amount of the node H.

It is noted that the foregoing has described a non-limiting instance where a flow amount is divided equally in accordance with the number of edges connected to a node. For instance, the ratio of distribution may be different edge-by-edge in accordance with a specific trading volume or other things. One of ordinary skill in the art would be easily understand that a path weight calculation is possible in this case as well, based on the weight of a corresponding edge. Further, when an entity network is a network representing a stock-market control relationship for instance, the weight of each edge may be determined in accordance with a shareholding ratio.

### 2.6.3 Tag-Transition-Pattern Weight

Processing to calculate a tag-transition-pattern weight, which corresponds to Steps S602 to S605 in FIG. 16, will be described. In Step S602, for each of a plurality of paths included in an entity network, the path selecting unit 115 may determine a tag transition pattern corresponding to the path in accordance with the tag value of a node on the path, and may set a path weight as the tag-transition-pattern weight of the tag transition pattern as determined. In Steps S603 to S605, in response to duplication of the tag transition pattern among two or more of the plurality of paths, the path selecting unit 115 then updates the tag-transition-pattern weight by summing the tag-transition-pattern weights determined for the respective two or more paths. For instance, consider a transition of a tag representing an industrial classification as earlier described; in this case, there may be patterns in which their tag transitions in the industrial classification are the same though companies appearing on the path are different. For instance, the node B and node C in FIG. 18 are provided with a tag b, which represents the same industrial classification. Accordingly, in processing targeted on an industrial classification, there is sometimes no need to distinguish the node B from the node C. The technique in this embodiment enables appropriate weight setting reflecting such a case in which there is an industrial-classification duplicate transition (in a wide sense, a tag transition pattern) among different paths. The following describes the details.

Reference is made to the path ABDI in the supply chain network in FIG. 18. The node A is associated with the alphabet a, which is a tag value representing an industrial classification. The node B is associated with the alphabets b and c as tag values. The node D is associated with the alphabets d and e as tag values. The node I is associated with the alphabet h as a tag value.

That is, there are four possible tag transition patterns: abdh, abeh, acdh, and aceh, each representing how the tag value changes along the path ABDI. It is noted that abdh represents a tag transition pattern in which the tag values a, b, d, and h, provided to respective four nodes, appear in the stated order in the case of a transition of these four nodes. The same holds true for the other examples. Accordingly, the path selecting unit 115 sets the path weight of the path ABDI at 0.0625 as the tag-transition-pattern weight of each of the four tag transition patterns abdh, abeh, acdh, and aceh.

The same holds true for the other paths. The number of kinds of tag transition pattern along each path is the following: four patterns along the path ABDJ; four patterns along the path ABEJ; two patterns along the path ABFJ; two patterns along the path ABFK; two patterns along the path ABGJ; two patterns along the path ABGK; two patterns along the path ACGJ; two patterns along the path ACGK; and two patterns along the path ACHK. The path selecting unit 115 sets, as tag-transition-pattern weights, path weights corresponding to the respective 26 tag transition patterns determined from the 10 paths.

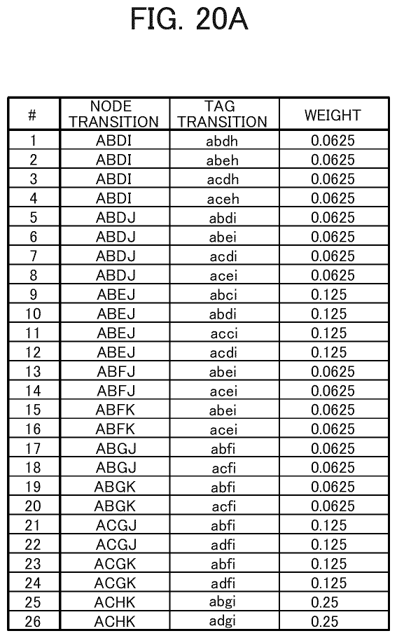

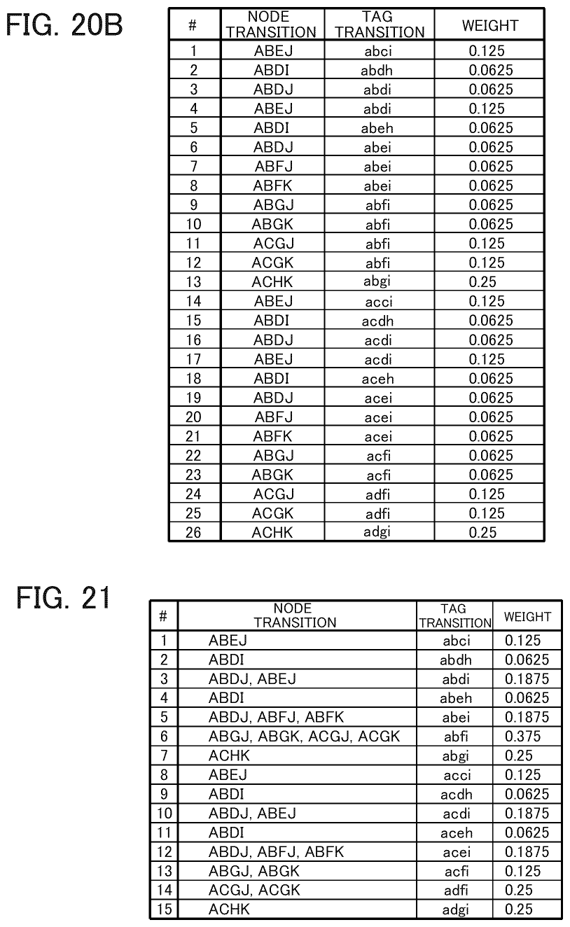

FIG. 20A is a table showing examples of a tag-transition-pattern weight assigned to each tag transition pattern through the foregoing processing. As earlier described, there are four tag transition patterns corresponding to the path ABDI: abdh, abeh, acdh, and aceh, and for each pattern, a weight of 0.0625, which is the same as the path weight of the path ABDI, is set (#1 to #4 in FIG. 20A). There are four tag transition patterns corresponding to the path ABDJ: abdi, abei, acdi, and acei, and for each pattern, a weight of 0.0625, which is the same as the path weight of the path ABDJ, is set (#5 to #8 in FIG. 20A). The same holds true for the other paths; the results are shown in FIG. 20A. The foregoing corresponds to the processing in Step S602 in FIG. 16.

Next, in response to duplication of the tag transition pattern among the plurality of paths, the path selecting unit 115 updates the tag-transition-pattern weight by summing the weights of the duplicate tag transition patterns, as shown in Steps S603 to S605.

FIG. 20B is a table showing the 26 tag transition patterns and their tag-transition-pattern weights described with reference to FIG. 20A, sorted based on tag transition patterns. It is noted that #1 to #26 are renumbered in this sorting.

For example, the tag transition pattern abci in #1 appears only in the path ABEJ and does not appear in the other paths (NO in Step S603). Accordingly, the path selecting unit 115 sets the tag-transition-pattern weight of the tag transition pattern abci at 0.125 as is, which is determined from the path weight of the path ABEJ.

Further, the tag transition pattern abdh in #2 appears only in the path ABDI and does not appear in the other paths (NO in Step S603). Accordingly, the path selecting unit 115 sets the tag-transition-pattern weight of the tag transition pattern abdh at 0.0625 as is, which is determined from the path weight of the path ABDI.

On the other hand, as shown in #3 and #4, the tag transition pattern abdi appears in two paths: the paths ABDJ and ABEJ. The tag transition pattern abdi corresponding to the path ABDJ is set at 0.0625 as its tag-transition-pattern weight, and the tag transition pattern abdi corresponding to the path ABEJ is set at 0.125 as its tag-transition-pattern weight. The path selecting unit 115 in this case sums these two tag-transition-pattern weights to update the tag-transition-pattern weight (Step S604). In this example, through the update, the tag-transition-pattern weight of the tag transition pattern abdi is updated to 0.0625+0.125=0.1875.

For the other tag transition patterns, the path selecting unit 115 likewise updates the tag-transition-pattern weight by summing the weights of duplicate tag transition patterns determined in FIG. 20A.

FIG. 21 is a table showing examples of a tag-transition-pattern weight after update. FIG. 21 shows the relationships of a tag transition pattern, a tag-transition-pattern weight, and one or more paths corresponding to the tag transition pattern. As shown in FIG. 21, the weights of duplicate tag transition patterns are integrated into one, thereby determining the tag-transition-pattern weight of each of the 15 tag transition patterns that are not mutually duplicate.

### 2.6.4 Selection of Priority Path

Processing to select a priority path, which corresponds to Step S606 in FIG. 16, will be described. The path selecting unit 115 may select, from among a plurality of paths, one or more candidate paths whose tag-transition-pattern weights along the corresponding paths are maximum, and select, as a priority path, a path whose path weight is determined as being relatively large among those of the one or more candidate paths. The technique in this embodiment, which reflects both of the tag-transition-pattern weight and path weight, enables highly accurate priority path selection.

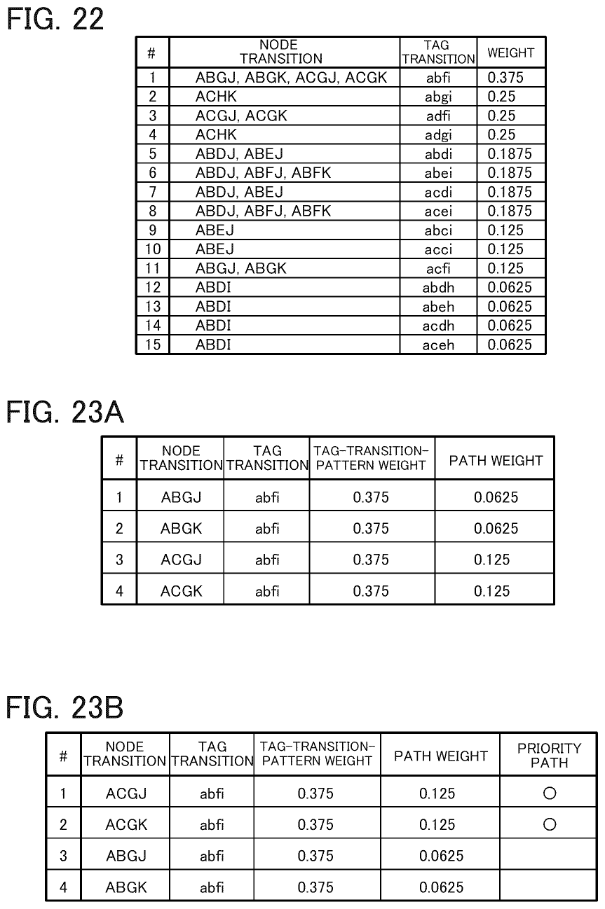

FIG. 22 is a table showing the 15 data pieces shown in FIG. 21, sorted in descending order of tag-transition-pattern weights. The path selecting unit 115 selects a tag transition pattern having a maximum tag-transition-pattern weight. In the example in FIG. 22, the tag transition pattern abfi has a weight of 0.375, which is maximum. Moreover, the tag transition pattern abfi is associated with four paths: ABGJ, ABGK, ACGJ, and ACGK. The path selecting unit 115 accordingly selects these four paths as candidates for a priority path.

FIG. 23A is a table showing information about the four selected candidate paths. FIG. 23A shows path (node transition) information, tag-transition-pattern information, tag-transition-pattern-weight information, and path weight information. In some cases, a plurality of tag transition patterns correspond to a single path, as earlier described with reference to FIG. 20A. However, since the candidate paths herein are selected based on the tag transition pattern abfi, only the information about the tag transition pattern abfi is associated as the tag transition pattern and tag-transition-pattern weight.

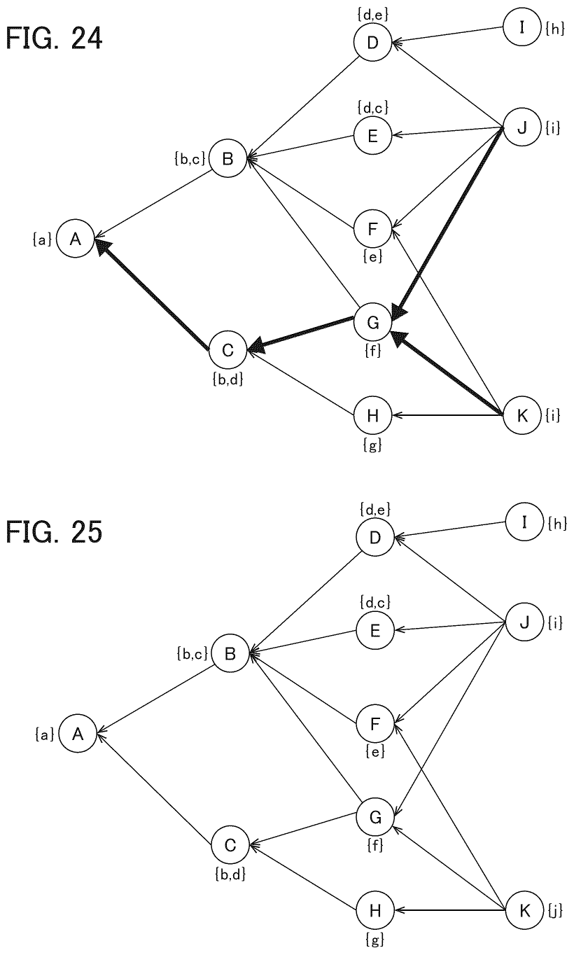

FIG. 23B is a table showing the four data pieces shown in FIG. 23A, sorted in descending order of path weights. Herein, the paths ACGJ and ACGK have a path weight of 0.125, and the paths ABGJ and ABGK have a path weight of 0.0625. The path selecting unit 115 accordingly selects the paths ACGJ an ACGK, whose path weights are relatively large, as priority paths. FIG. 24 illustrates the priority paths in this case on the network.

It is noted that a priority path herein may be information including both node transition (in a narrow sense, path) information and tag transition (tag-transition-pattern) information. For instance, the path ACGJ corresponds to the tag transition patterns abfi and adfi, as shown in #21 and #22 in FIG. 20A. Between the two, one that is more important than the other is the tag transition pattern abfi, which has a larger tag-transition-pattern weight. That is, in the path ACGJ, although the node C belongs to both an industrial classification corresponding to the tag value b, and an industrial classification corresponding to the tag value d, the path ACGJ has high priority when the node C functions as a company belonging to the industrial classification corresponding to the tag value b. Conversely, when the node C functions as a company belonging to the industrial classification corresponding to the tag value d, it is conceivable that the importance of a trading relationship in which the nodes A, C, G, and J are connected together in the stated order, is relatively low. Accordingly, the information processing system 10 according to this embodiment may output the tag transition pattern as well as the node transition (path in a narrow sense; e.g., FIG. 24) information when outputting the priority paths to the terminal device 200.

The foregoing has described processing to select candidate paths based on tag-transition-pattern weights, and compare the path weights of the selected candidate paths with one another. However, the processing in this embodiment is non-limiting; the tag-transition-pattern weight and path weight may be used in combination in another method. For instance, the path selecting unit 115 may select, as a candidate path, a path whose tag-transition-pattern weight is equal to or greater than a predetermined threshold (alternatively, equal to or greater than a predetermined upper proportion of the whole). This increases the number of selected candidate paths, thus enabling processing with the tag-transition-pattern weight and path weight reflected with balance. Alternatively, the path selecting unit 115 may determine the feature amount by using a given function with the tag-transition-pattern weight and path weight as arguments, and select, as the priority path, a path whose feature amount is maximum. An example of the function herein is a function for determining a weighted mean, but other functions may be used. Other than the foregoing, various modifications can be made to a specific example of the processing by the use of the tag-transition-pattern weight and path weight.

### 2.6.5 Other Network Examples

FIG. 25 illustrates another example of the supply chain network. The network illustrated in FIG. 25 is similar to the supply chain network described with reference to FIG. 18 with the exception that the node K in FIG. 25 is provided with a tag j.

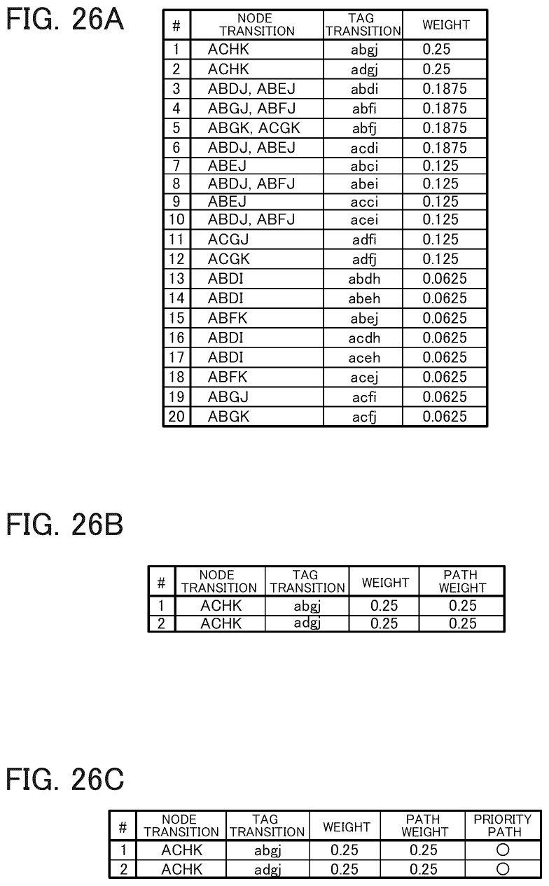

FIGS. 26A to 26C are tables showing the results of the process described with reference to FIG. 16, performed on the network illustrated in FIG. 25. FIG. 26A is a table showing tag-transition-pattern weights determined after the completion of the processing in Steps S601 to S605, and sorted in descending order of the tag-transition-pattern weights. FIG. 26A is similar to FIG. 22. In this example, the tag transition patterns abgj and adgj have a weight 0.25, which is maximum.

FIG. 26B shows candidate paths selected based on the tag-transition-pattern weights, and corresponds to FIG. 23A. FIG. 26C shows processing to select priority paths from the candidate paths, and corresponds to FIG. 23B.

In the processing targeted on the network in FIG. 25, the path ACHK is selected (FIG. 26B) as a candidate path corresponding to both of the tag transition patterns abgj and adgj, both of which have an equal path weight, and the path ACHK is thus selected as a priority path (FIG. 26C). As seen from this example, a plurality of tag transition patterns in a single path may be set as priority paths in the the technique in this embodiment.

For instance, as earlier described, a priority path in this embodiment may include both node transition information and a tag transition pattern. In the examples in FIGS. 25 to 26C, there is only one priority path in terms of node transition (in a narrow sense, path): the path ACHK, which is associated with two tag transition patterns: abgj and adgj. Outputting tag-transition-pattern information to the terminal device 200 allows the user to recognize that, for instance, a company corresponding to the node C is a company of high importance both when the company functions as a company belonging to an industrial classification corresponding to the tag value b, and when the company functions as a company belonging to an industrial classification corresponding to the tag value d.

### 2.6.6 Subnetwork

The foregoing has described an example (FIG. 18) where a processing target is a supply chain network in which the node A corresponding to an entity of interest constitutes one end of the network. The other end of the supply chain network is not limited in this example; for instance, all the nodes I, J, and K, which constitute upstream ends, are included in processing targets.

However, in network analysis, there is conceivably a demand for analyzing the relationship between two entities. For example, to analyze the trading relationship between a company of interest and a specific company (e.g., an adversary company or a company with high trading risk), determining a priority path between the company of interest and specific company is useful. Accordingly, the path selecting unit 115 may perform processing to receive a selection input of two entities, and to determine a priority path connecting the two entities together.

FIG. 27 illustrates an example of the subnetwork of the supply chain network illustrated in FIG. 18. Herein, let the nodes A and J be selected. Thus, the subnetwork in FIG. 27 is composed by extracting, from the supply chain network in FIG. 18, edges and nodes connected directly or indirectly to the nodes A and J. It is noted that extracting part of a network as a subnetwork is publicly known processing and will not be thus detailed.

In this case, the subnetwork is part of the supply chain network, and thus, the path selecting unit 115 can use the result of the processing targeted on the entire supply chain network. To be specific, the path selecting unit 115 extracts a necessary part of data obtained by subjecting the supply chain network illustrated in FIG. 18 to the processing in Steps S601 to S605 in FIG. 16 (e.g., the table shown in FIG. 22), and the path selecting unit 115 uses the extracted part in the processing targeted on the subnetwork illustrated in FIG. 27.

FIG. 28A is a table showing tag transition patterns sorted in descending order of their tag-transition-pattern weights, and is an excerpt from the data shown in FIG. 22, related to the subnetwork shown in FIG. 27. In the example in FIG. 27, since one end of the subnetwork is the node J, the path selecting unit 115 executes processing to extract only items in which the fourth element of the node transition (in a narrow sense, path) is J. In this case, as shown in FIG. 28A, the tag transition pattern abfi has a weight of 0.375, which is maximum.

FIG. 28B shows candidate paths selected based on the tag-transition-pattern weights. FIG. 28C shows processing to select a priority path from the candidate paths. As shown in FIG. 28B, the paths ABGJ and ACGJ are selected as candidate paths corresponding to the tag transition pattern abfi. Moreover, between the paths ABGJ and ACGJ, the path ACGJ, whose path weight is relatively large, is selected as a priority path, as shown in FIG. 28C.

As described above, the the technique in this embodiment enables appropriate priority path selection even within a subnetwork. This can select, for instance, a priority path connecting two designated entities together. At this time, the result of processing targeted on the entire network can be used also in processing targeted on its subnetwork. This enables high-speed priority path selection even in response to a change of a subnetwork to be extracted. For instance, although the foregoing has described an instance where a priority path is determined between the nodes A and J, a priority path can be selected at high speed even in response to a change of processing target nodes to other nodes.

### 2.6.7 Other Tag Examples

The foregoing has described an instance where tag values represent industrial classifications (industrial classifications b to j). It is noted a tag in this embodiment is not limited to information indicating a single kind of attribute; a tag may be information in which a plurality of attributes are combined together. In this case, information in which the attribute value of a first attribute and the attribute value of a second attribute are combined together is provided as a tag value to each node in the first network 121 and second network 122.

A tag herein may be, for instance, information for specifying a combination of an industrial classification and a country. For example, N1 to Nx (here, x is an integer equal to or greater than two) may be provided to each node as tag values representing countries. For instance, when an entity corresponding to the node A is a company of an industrial classification a belonging to the country N1, the node A is provided with a tag value (a:N1), which represents a combination of N1 and a. In addition, when an entity corresponding to the node B is a company of an industrial classification b belonging to the country N1, and is also a company of an industrial classification c belonging to the country N1, the node B is provided with tag values (b:N1) and (c:N1). For the other nodes as well, a single tag value is represented by a combination of an industrial classification and a country.

As described above, the path selecting unit 115 can determine the path weight in a manner similar to the foregoing technique even when the tag value is a combination of a plurality of attribute values. Further, there is no change in the processing to determine the tag transition pattern and the processing to determine the tag-transition-pattern weight, with the exception that the tag transition pattern is a union of tag values represented by combinations of an industrial classification and a country. Accordingly, the path selecting unit 115 can determine the priority path through a process similar to that described with reference to FIG. 16 to FIG. 28C.

### 3. Modifications of Additional Data

The foregoing has described, by way of example, providing a tag, which is additional data, to a node, and determining the path weight and tag-transition-pattern weight as the feature amount. However, the additional data and the feature amount determined from the additional data are not limited to the above.

For instance, an embedding vector corresponding to a text representing a node characteristic may be provided to a node as the additional data. Moreover, the path selecting unit 115 may select the priority path by determining the feature amount based on the embedding vector. This enables appropriate evaluation on a node-to-node relationship by the use of language information, which is texts.

### 3.1 Process Steps

FIG. 29 illustrates one example of the path selection processing shown in Step S106 in FIG. 4, and is a flowchart of the processing by the use of an embedding vector. In Step S701, the path selecting unit 115 firstly obtains an embedding vector corresponding to each node.

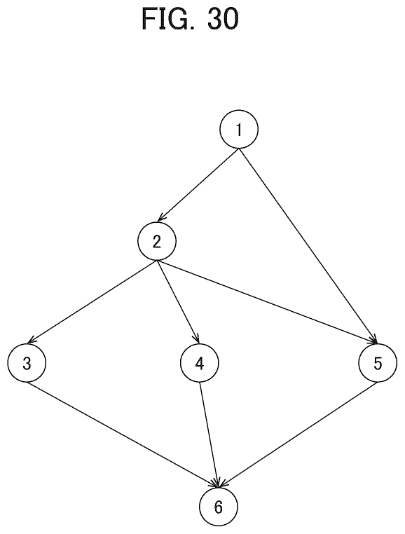

FIG. 30 illustrates an example of a processing target network (e.g., a supply chain network). Reference is made to a simple network including six nodes: the nodes 1 to 6.

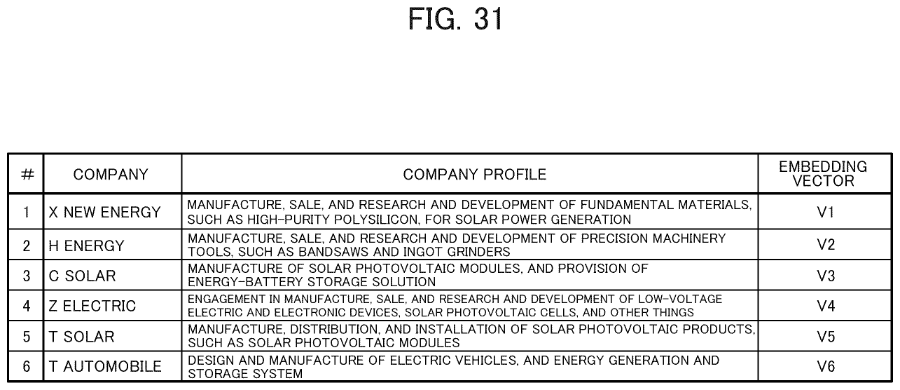

FIG. 31 illustrates the relationship between a company corresponding to each node, a text (company profile), and an embedding vector. For instance, the node 1 is a company named “X NEW ENERGY” and is associated with a text “MANUFACTURE, SALE, AND RESEARCH AND DEVELOPMENT OF FUNDAMENTAL MATERIALS, SUCH AS HIGH-PURITY POLYSILICON, FOR SOLAR POWER GENERATION,” as its company profile. The company profile is a text representing a company characteristic. The node 1 is also associated with an embedding vector V1 obtained by vectorizing the company profile. It is noted that embedding is processing to convert words and phrases into mathematically tractable information by positioning them in a vector space, in the field of natural language processing. An embedding vector in this embodiment is a vector obtained by converting a target text into mathematical information. It is noted that there are various specific techniques for converting a text into mathematical information; since they are widely applicable in this embodiment, their detailed descriptions will be omitted.

The information shown in FIG. 31 is obtained when, for instance, the network obtaining unit 111 obtains an entity network. The information processing system 10 may obtain the company profile by using open information, such as the company's website or securities reports. The embedding vector can be determined through a publicly known technique once the company profile is obtained, as earlier described. The same holds true for information corresponding to the nodes 2 to 6. In Step S701 in FIG. 29, the path selecting unit 115 performs, for instance, processing to obtain embedding vectors V1 to V6 from the tabular data in FIG. 31, which is stored in the storage unit 120.

In Step S702, upon selection of a first node included in the entity network, and a second node included in the entity network and connected to the first node via a node different from the first node, the path selecting unit 115 determines a first difference vector representing the difference between a first embedding vector, which is an embedding vector provided to the first node, and a second embedding vector, which is an embedding vector provided to the second node. As will be described later on, the first difference vector is used for feature amount calculation.

The first and second nodes are, to be specific, nodes that undergo priority path determination. In other words, upon selection of the first and second nodes, the path selecting unit 115 performs processing to select a priority path having these two nodes as its endpoints. It is noted that the selection here may be made by the user of the terminal device 200, or by the path selecting unit 115 automatically. For example, in the network illustrated in FIG. 30, the first node may be the node 1, which is an upstream end node, and the second node may be the node 6, which is a downstream end node. The technique in this embodiment enables the relationship between nodes at both ends that are targets of priority path determination, to be expressed by the use of the first difference vector. The first difference vector may be considered as information indicating the schematic relationship (macroscopic relationship) between the nodes 1 and 6.

In Step S703, for each of a plurality of edges included in a subnetwork having the first node as one endpoint, and the second node as the other endpoint, the path selecting unit 115 determines a second difference vector representing the difference between an embedding vector provided to the node at one end of the edge, and an embedding vector provided to the node at the other end of the edge.

Here, the edge connecting nodes X and Y together is denoted as EXY. In the example in FIG. 30, there are eight edges in the subnetwork connecting the first and second nodes together: E12, E15, E23, E24, E25, E36, E46, and E56. The path selecting unit 115 determines the second difference vector for each of these eight edges. This enables the relationship between nodes adjacent between the first and second nodes to be represented by the use of the second difference vector. The second difference vector may be considered as information indicating the local relationship (microscopic relationship) between the adjacent nodes.

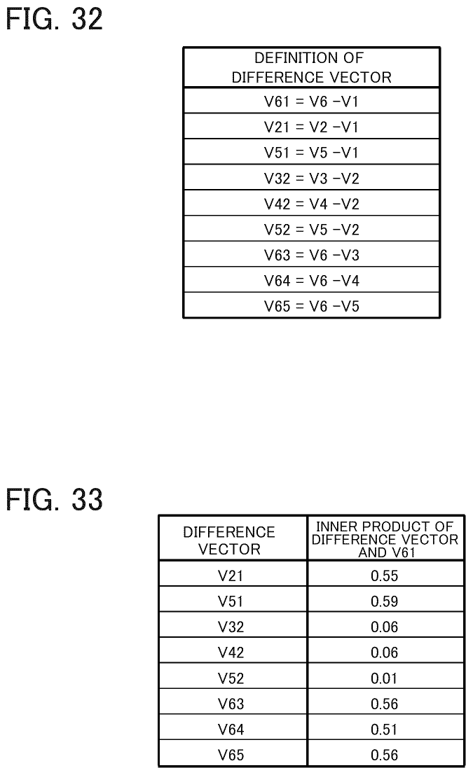

FIG. 32 is a table showing the definitions of difference vectors. For example, a difference vector may be a vector whose positive direction is directed from the upstream side to downstream side of a network. In this case, the difference vector (first difference vector) of the nodes 1 and 6 is denoted as a vector V61, which is obtained by subtracting the embedding vector V1 of the node 1 from the embedding vector V6 of the node 6. Further, the difference vector (second difference vector) of the nodes 1 and 2 is denoted as a vector V21, which is obtained by subtracting the embedding vector V1 of the node 1 from the embedding vector V2 of the node 2. The same holds true for the other difference vectors.

In Step S704, for each of the plurality of edges included in the subnetwork connecting the first and second nodes together, the path selecting unit 115 determines the inner product of the first and second difference vectors as an edge feature amount. To be specific, among the difference vectors shown in FIG. 32, the path selecting unit 115 determines the inner product of V61, which is the first difference vector, and each of V21, V51, V32, V42, V52, V63, V64, and V65, all of which are the second difference vectors. Doing so can evaluate, as an inner product value, how much the macroscopic relationship between the nodes 1 and 6 is correlated with the microscopic relationship between the adjacent nodes. The larger the inner product value is, the higher the degree of correlation between the macroscopic and microscopic relationships is.

FIG. 33 is a table showing examples of the inner product of the first and second difference vectors. The table shows that the inner product value of the first difference vector V61 and second difference vector V21 stands at 0.55, which is relatively large. That is, in the network in FIG. 30, the relationship between the nodes 1 and 2, which are two adjacent nodes corresponding to V21, conceivably matches the macroscopic relationship between the nodes 1 and 6 to a high degree. Likewise, V51, V63, V64, and V65 have a large inner product value, and hence, their relationships between the corresponding two nodes match the macroscopic relationship to a high degree. On the other hand, V32, V42, and V52 have a relatively small inner product value, and hence, their relationships between the corresponding two nodes conceivably match the macroscopic relationship to a low degree.

In Step S705, for each of a plurality of paths connecting the first and second nodes together, the path selecting unit 115 determines a path feature amount based on the edge feature amount (inner product) of the edge included in the path.

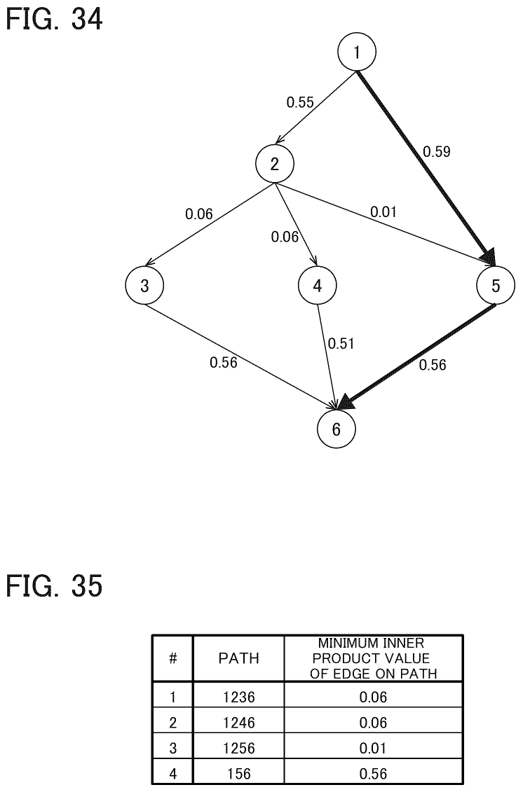

FIG. 34 illustrates edge feature amounts (inner products) on a network. There are four possible paths connecting the nodes 1 and 6 together: paths 1236, 1246, 1256, and 156. In the path 1236, the nodes are connected together via three edges, i.e., E12, E23, and E36; thus, the feature amount of the path 1236 is determined based on the inner product values of the three, i.e., 0.55, 0.06, and 0.56. The same holds true for the other paths. Doing so can determine the feature amount of each path from the degree of match between multiple microscopic relationships along the path and a macroscopic relationship along the path.

To be specific, for each of the plurality of paths connecting the first and second nodes together, the path selecting unit 115 may select, as the feature amount of the path, a minimum value from among the edge feature amounts of the edges included in the path. FIG. 35 illustrates the feature amounts of the respective paths in this case. In the path 1236, the edge E23 has a minimum edge feature amount, i.e., 0.06; thus, this vale is set as the feature amount of the path 1236. Likewise, in the path 1246, the edge E24 has a minimum edge feature amount, i.e., 0.06. In the path 1256, the edge E25 has a minimum edge feature amount, i.e., 0.01. In the path 156, the edge E56 has a minimum edge feature amount, i.e., 0.56.

In Step S706, the path selecting unit 115 may select, from among the plurality of paths, a path whose feature amount is maximum, as the priority path connecting the first and second nodes together. The path 156 has a maximum feature amount in the foregoing example, as clearly seen from FIG. 35; thus, the path selecting unit 115 selects the path 156 as the priority path between the nodes 1 and 6. Accordingly, a path including an edge with a low degree of match with the macroscopic relationship can be easily excluded from the priority path. In other words, a path with the conceivably smallest inconsistency between the macroscopic and microscopic relationships is selected as the priority path. However, the technique for determining a path feature amount from an edge feature amount is non-limiting; various modifications are possible, an example of which is determining the average of edge feature amounts as the path feature amount.

This embodiment has been detailed as described above. A person skilled in the art will readily appreciate that many modifications are possible without substantially departing from the new matters and advantageous effects of the present embodiment. Accordingly, all such modifications are included in the scope of the present disclosure. For instance, terms appeared at least once in the Specification or in the drawings along with other broader or synonymous terms can be replaced with the other broader or synonymous terms in any part of the Specification or the drawings. Further, all combinations of this embodiment and its modifications are encompassed in the scope of the present disclosure. Furthermore, the configurations and operations of the information processing system, server system, terminal device, and others are not limited to those described in this embodiment. Their modifications are possible in various manners.

What is claimed is:

1. An information processing system comprising:
a network obtaining unit configured to obtain an entity network in which a plurality of nodes corresponding one-to-one to a plurality of entities are connected together by edges each representing a trading relationship or a control relationship; and
a path selecting unit configured to select a priority path of high priority from among a plurality of paths included in the entity network,
wherein each of the plurality of nodes included in the entity network is provided with additional data representing a characteristic of the node, and
the path selecting unit determines, for each of the plurality of paths, a feature amount based on the additional data, and selects the priority path based on the feature amount as determined.

2. The information processing system according to claim 1, wherein
the node is provided with, as the additional data, a tag including one or more of a plurality of tag values,
the path selecting unit determines a path weight and a tag-transition-pattern weight as the feature amount, the path weight indicating a weight of each of the plurality of paths, the tag-transition-pattern weight being a weight of a tag transition pattern indicating how the one or more tag values transition when the node transitions along the path, and
the path selecting unit selects the priority path based on the path weight and the tag-transition-pattern weight.

3. The information processing system according to claim 2, wherein
the path selecting unit selects, from among the plurality of paths, one or more candidate paths whose tag-transition-pattern weights along the respective paths are maximum, and
the path selecting unit selects, as the priority path, the path whose path weight is determined as being relatively large among those of the one or more candidate paths.

4. The information processing system according to claim 2, wherein
for each of the plurality of paths included in the entity network, the path selecting unit determines the path weight based on the trading relationship or the control relationship of the node on the path.

5. The information processing system according to claim 4, wherein
the path selecting unit determines, for each of the plurality of paths included in the entity network, the tag transition pattern corresponding to the path in accordance with the one or more tag values of the node on the path, and sets the path weight as the tag-transition-pattern weight of the tag transition pattern as determined, and
in response to duplication of the tag transition pattern among two or more of the plurality of paths, the path selecting unit updates the tag-transition-pattern weight by summing the tag-transition-pattern weights determined for the respective two or more paths.

6. The information processing system according to claim 2, wherein the tag is information indicating at least one of an industrial classification and a country.

7. The information processing system according to claim 1, wherein
the node is provided with, as the additional data, an embedding vector corresponding to a text representing a characteristic of the node, and
the path selecting unit selects the priority path by determining the feature amount based on the embedding vector.

8. The information processing system according to claim 7, wherein
upon selection of a first node included in the entity network, and a second node included in the entity network and connected to the first node via the node different from the first node, the path selecting unit determines the feature amount based on a first difference vector representing a difference between a first embedding vector and a second embedding vector, the first embedding vector being the embedding vector provided to the first node, the second embedding vector being the embedding vector provided to the second node.

9. The information processing system according to claim 8, wherein
for each of a plurality of edges included in a subnetwork having the first node as one endpoint, and the second node as another endpoint, the path selecting unit determines a second difference vector, and determines an inner product of the first and second difference vectors as an edge feature amount, the second difference vector representing a difference between the embedding vector provided to the node at one end of the edge, and the embedding vector provided to the node at another end of the edge, and
for each of the plurality of paths connecting the first and second nodes together, the path selecting unit determines the feature amount of the path in accordance with the edge feature amount of the edge included in the path.

10. The information processing system according to claim 9, wherein
for each of the plurality of paths connecting the first and second nodes together, the path selecting unit selects, as the feature amount of the path, a minimum value among the edge feature amounts of the plurality of edges included in the path, and
the path selecting unit selects, as the priority path connecting the first and second nodes together, a path whose feature amount is maximum among those of the plurality of paths.

11. A method of information processing that is performed by an information processing device, the method comprising:
obtaining an entity network in which a plurality of nodes corresponding one-to-one to a plurality of entities are connected together by edges each representing a trading relationship or a control relationship,
wherein each of the plurality of nodes included in the entity network is provided with additional data representing a characteristic of the node;
for each of a plurality of paths included in the entity network, determining a feature amount based on the additional data; and
selecting, from among the plurality of paths, a priority path of high priority based on the feature amount as determined.
